(19) United States
(12) Patent Application Publication
(10) Pub. No.: US 2015/0039987 A1
(43) Pub. Date: Feb. 5, 2015

(54) SYSTEMS AND METHODS FOR DATA ENTRY

(71) Applicant: Plum Interfaces, LLC, Salt Lake City, UT (US)

(72) Inventor: Jason M. Soulier, Salt Lake City, UT (US)

(73) Assignee: Plum Interfaces, LLC

(21) Appl. No.: 14/444,778

(22) Filed: Jul. 28, 2014

Related U.S. Application Data
(60) Provisional application No. 61/860,018, filed on Jul. 30, 2013.

(51) Int. Cl. G06F 17/24; H04L 29/06; G06F 17/22

(52) U.S. Cl. CPC G06F 17/243; G06F 17/2247; H04L 67/42
USPC 715/224

(57) ABSTRACT

Systems and methods are disclosed for inputting data into a computing device, and particularly for presenting form content on a computing device having a limited viewing area for receiving input from a user. A protocol or other data is obtained that specifies a plurality of fields into which input data can be entered. Each field is associated with a field group. The field group specifies an ordering of all fields assigned to the field group. The fields are presented in series, one at a time, on a display screen of the computing device. The presentation occurs according to an ordering specified in the field group. Input data is received as it is entered into each field of the plurality of fields during a data entry session. The input data is incorporated into form data corresponding to the data entry session. The form data is made accessible to a third-party application.

### RELATED APPLICATIONS

This application claims priority to U.S. Provisional Patent Application No. 61/860,018, titled SYSTEMS AND METHODS FOR FORM CONTENT PRESENTATION AND DATA ENTRY ON A COMPUTING DEVICE, filed Jul. 30, 2013, which is hereby incorporated herein by reference in its entirety.

### COPYRIGHT NOTICE

© 2014 Plum Interfaces, LLC. A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 C.F.R. §1.71(d).

### TECHNICAL FIELD

The present disclosure is directed to data entry or collection, and more particularly to systems and methods for facilitating data input on a computing device having a limited display or viewing area.

### BRIEF DESCRIPTION OF THE DRAWINGS

Understanding that drawings depict only certain preferred embodiments and are not therefore to be considered to be limiting in nature, the preferred embodiments will be described and explained with additional specificity and detail through the use of the accompanying drawings.

FIG. 1 is a representation of a form in a paper medium, according to one embodiment.

FIG. 2 is a flow diagram of a method for organizing form content into logical field groups, according to one embodiment.

FIG. 3 is a flow diagram of a method for refining logical field groups into reasonable sets of fields, according to one embodiment.

FIG. 4 is a data set representation of form content, according to one embodiment.

FIG. 5 is a system of data collection according to one embodiment.

FIG. 6 is a flow diagram of a form administrator's interactions and uses of the system of FIG. 5, according to one embodiment.

FIG. 7 is an interface, according to one embodiment, to create new form content and/or identify a business process.

FIG. 8 is an interface, according to one embodiment, to organize form content into logical field groups and/or refine logical field groups.

FIG. 9 is an interface, according to one embodiment, to enable approved form users and/or enable approved computing devices.

FIG. 10 is a flow diagram of a form user's interactions and uses of the system of FIG. 5, according to one embodiment.

FIG. 11 is a user interface, according to one embodiment, to download new and/or updated protocols and to select an appropriate protocol for a data entry session.

FIG. 12 is a user interface, according to one embodiment, to open a data entry session.

FIG. 13 is a radio button field entry interface, according to one embodiment, to enter a single radio button field where a variety of pre-defined values are presented and one and only one value may be selected.

FIG. 14 is a checkbox field entry interface, according to one embodiment, to enter a checkbox field where pre-defined values are presented and one or several values may be selected.

FIG. 15 is a text field entry interface, according to one embodiment, to enter input data into a text field.

FIG. 16 is a text field entry interface, according to another embodiment, to enter data into a text field.

FIG. 17 is a text field entry interface, according to one embodiment, to enter data into a text field.

FIG. 18 is an interface, according to one embodiment, to verify field data values at the conclusion of a logical field group.

FIG. 19 is an interface, according to one embodiment, to implement character-by-character voice recognition.

FIG. 20 is a virtual keyboard interface of a form data capture device, according to one embodiment.

FIG. 21 is a virtual keyboard interface of a form data capture device, according to another embodiment.

FIG. 22 is a schematic diagram of a form data capture device, according to one embodiment of the present disclosure.

FIG. 23 is a schematic diagram of a form interface of a form data capture device, according to one embodiment of the present disclosure.

### DETAILED DESCRIPTION

A form may be an assimilation of fields, labels, instructions, and layout meant to capture desired or needed data, such as for a business process or other organization process. As used herein, the term “form” may refer to a collection of form content (e.g., fields, labels, instructions) configured to collect form data during a data entry session. In a paper medium, a form may originate from a template that can be copied to be repeatedly used. An example of a form in an electronic medium is a web page that can be repeatedly presented, once for each data entry session with a user. A partially or fully completed form may be referred to as a form instance. The form (e.g., the form content) may be included with the form data in a particular form instance resulting from a data entry session. The form instance may document or record, for example, performance of a task in an organization process. In other words, a form instance may be a particular instance of a completed form, including both form content and form data.

Forms are traditionally filled out in a single, continuous task, with each field entered in succession from the top to the bottom of the page. Such an approach may be appropriate for a paper medium or a computing device with a larger display, but can be impractical and present challenges when the desired medium to complete a form is a computing device with a limited viewable interactive area, such as a mobile and/or handheld computing device. Efficient use of computing devices (and particularly mobile computing devices) to complete forms may require fundamentally reorganizing form content. Form content organizational concepts are discussed herein followed by a description of example systems and methods that reorganize form content for enabling efficient data input using a computing device, such as a mobile computing device.

### Form Content Organization

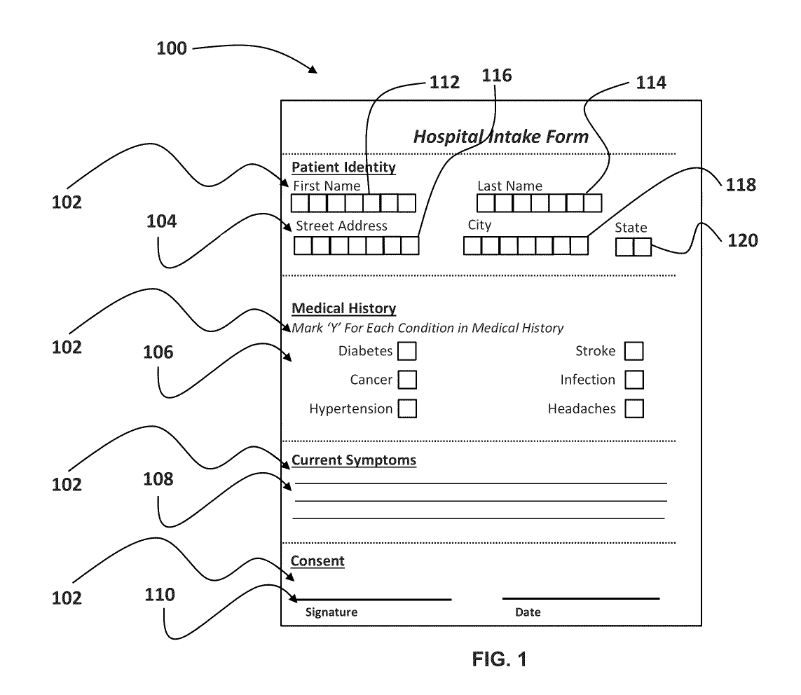

FIG. 1 is a representation of a form 100, such as a form in a paper medium, a web page medium, or the like, according to one embodiment. The illustrated form 100 includes a plurality of logical field groups 102, or sections of the form 100 that group natural subsets of form content and that are intended and/or configured to collect form data providing information related to a class or category, such as an information requirement of an organization process (e.g., a business process) that the form 100 may serve. As used herein, the term “organization process” includes any task or series of tasks an organization of any type or purpose may undertake by its members and/or by the general public to advance and/or accomplish a purpose (e.g., an organizational purpose). As used herein, the term “information requirement” refers to a class or category of information, data, confirmation, analysis, and/or other results that may be needed to fulfill a given organization process. One familiar example of a type of organization process is a business process for which business requirements are collected in order to accomplish the business process. The term “business” as used herein is not limited to commercial enterprises and includes any organization, including a single individual. The term “business,” as used herein, is intended merely as an example to help explain example embodiments and is not in any way intended to limit application of the present disclosure to a type of organization.

In the case of the form 100 of FIG. 1, the organization process served by the form 100 may be a business process of a hospital, or a home healthcare network, to receive a new patient and prepare for treatment of that new patient. Receiving a new patient and preparing for their treatment may have several business requirements (or information requirements) for data capture, and the data capture for each business requirement may be accomplished by fields in a logical field group 102 within the form 100. In FIG. 1, the form 100 may include the following logical field groups: Patient Identity 104, Medical History 106, Current Symptoms 108, and Consent for Treatment 110. When the data for each of these business requirements is captured (e.g., the desired or needed data is obtained), the business process of receiving a new patient and preparing for their treatment can be completed. As can be appreciated, logical field groups 102 can pertain to an organization process for any organization, industry, or application that may use forms to gather information requirements.

The logical field groups 102, as can be appreciated, may include any natural subsets of form content, including fields. Identifying logical field groups 102 may allow more manageable and intuitive input data entry in increments instead of completing an entire form at once and/or without groupings of naturally or logically related form content. The logical field groups may assist in making input data entry more manageable and intuitive. The included fields in a logical field group 102 may often be interdependent, and therefore addressable in a single seamless thought process by a form user. Working within a given logical field group 102, a form user may be able to complete successive entry of multiple fields without the need for ongoing context or instructions.

The possible interdependency of fields in a logical field group 102 can be seen in the paper form 100 in FIG. 1. Specifically, the logical field group Patient Identity 104 has five fields: First Name 112, Last Name 114, Street Address 116, City 118, and State 120. Since a patient can have only one primary residence, one or more of these fields is interdependent. Once the purpose of one field is understood, other fields in the logical field group can be completed without ongoing instructions. Additionally, the fields in Patient Identity 104 are a natural subset that may be logically grouped apart from other fields on the form 100, further demonstrating their potential to be identified as a logical field group 102.

Recognizing and defining logical field groups 102 may be assisted by visual clues in the form layout. Even if not consciously intended, forms are often created by considering each business requirement of the business process one by one, and adding form content to address each requirement as a discrete section of the form layout. As such, logical field groups 102 can often be recognized by a break in a form layout, a border, or a unique section heading or title.

Having described form organization in a paper medium, the following discussion turns to concepts and methods for organizing and generating forms generally, and particularly for organizing and generating forms for presentation and completion on a computing device.

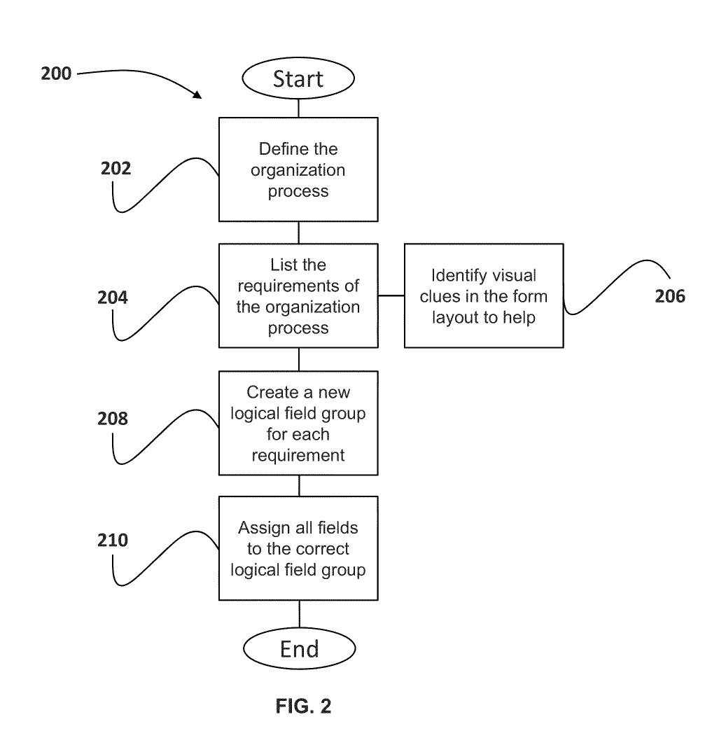

FIG. 2 is a flow diagram of a method 200 for organizing form content into logical field groups 102 for presentation on a computing device. The method 200 may be used for any application or industry. The purpose of a form, as defined originally, may be to capture data needed (e.g., information requirement(s)) for an organization process (e.g., a business process). Effective reorganization of form content into logical field groups 102 may include defining 202 the organization process that the form 100 is intended to serve. As stated previously, logical field groups 102 may be intended and/or configured to capture a single information requirement of the organization process that the form 100 may serve. Defining 202 an organization process may prime an analysis or determination of information requirements, and therefore identification of logical field groups 102, as well as provide a guide to ensure that needed logical field groups 102 are defined. In some embodiments, a sentence or two of prose may be sufficient to define an organization process.

With the organization process defined 202, information requirements of the organization process may be listed 204. Information requirements may include, but are not limited to, the who, what, when, where, why, and how of the organization process. (As can be appreciated, other information requirements may be possible.) Moreover, more involved or complex information requirements may be subdivided into smaller information requirements. Information requirements can also be identified by considering the inputs and the outputs of the organization process, with the inputs usually providing the requirements (including information requirements) of the organization process. If a form layout is already in use, such as in a paper media or a website media, then visual clues in the form layout, like a section heading or break in the flow of the layout, can be used to help identify 206 information requirements of the organization process. As stated above, the organization process definition 202 can be used to ensure completeness of a set of information requirements for the organization process.

A new logical field group 102 may be created 208 for each information requirement. In addition, one or more fields (e.g., form data input fields) can be gleaned and/or created that facilitate collection of data to meet each information requirement. One or more fields may be associated with an information requirement. All the form fields are assigned 210 to an appropriate logical field group, generally based on the associated information requirement. Defining each logical field group 102 may be a basis for a possible reorganization of form content for presentation and data entry on a computing device.

A form user may theoretically be able to complete an unlimited number of successive entries of field data within a single logical field group 102 without the need for ongoing context or instructions, given the uniformity and interdependency of its fields. However, space limitations in paper forms, interactive areas in computing devices, or limits on any other reasonable medium for capturing form content may limit the number of fields that may be continuously presented. For example, there may be a limit on the number of fields that form users may typically be willing to enter in succession without ongoing context or instructions being presented.

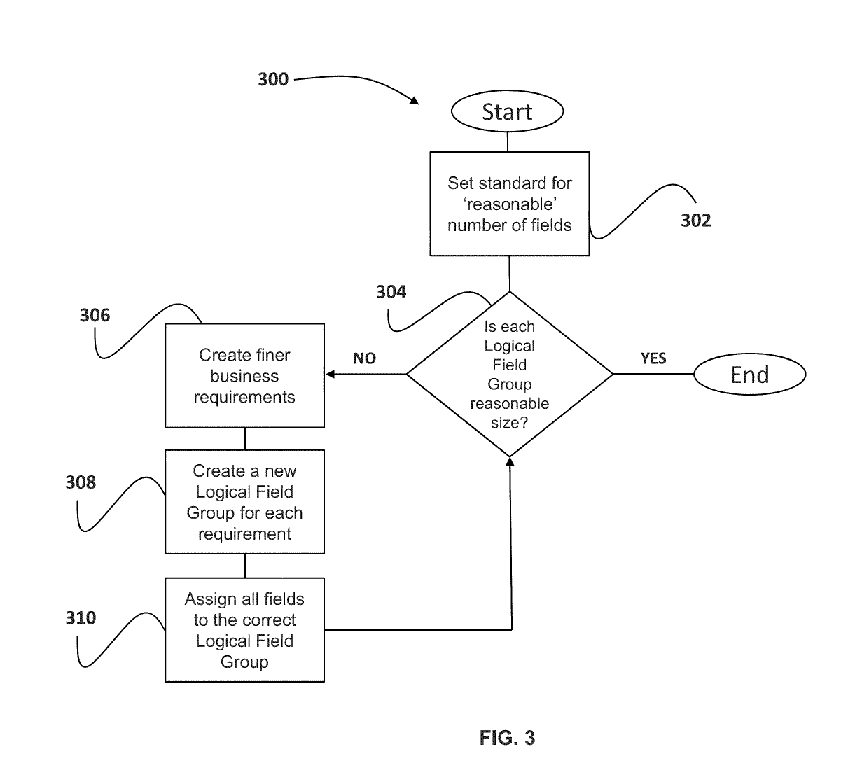

FIG. 3 is a flow diagram of a method 300 for refining logical field groups 102 into reasonable sets of fields. Organization of form content may be improved by setting a standard 302 for a “reasonable” number of fields to be entered in succession. A standard of reasonableness may depend on the application and the acumen of the form users and on the given form capture medium (e.g., the type of computing device), and may vary from instance to instance. An aim is to exercise and infuse an element of reality with respect to the organization of form content rather than to depend exclusively on the list of identified business requirements.

In the illustrated method 300, a standard for the reasonable number of fields is set 302. The standard may be set 302 through user input, consideration of user feedback, and/or analyzing form effectiveness and/or success measures, etc. With the standard for the reasonable number of fields set 302, one can consider or compare 304 the organization of logical field groups 102 against the standard to identify any logical field groups 102 that may be refined. For logical field groups 102 that are larger than the standard, finer information requirements can be created 306, for example by repeating the method 200 described in FIG. 2, with a finer breakdown of individual information requirements. For example, an information requirement might be to capture Medical History 106, but if the fields are too numerous, one may have to create sub-requirements of Medical History for respiratory health, mental health, digestive health, and so on until the information requirement is broken into finer requirements and the standard for reasonable number of fields is met.

Each time finer information requirements are created 306, a new logical field group 102 for each requirement is created 308, each of the fields is assigned 310 to an appropriate logical field group, and the resulting logical field groups 102 may be resubmitted to be compared 304 to the standard of reasonableness until all logical field groups 102 are of reasonable size (e.g., meet the standard for the reasonable number of fields). Again, logical field groups 102 of appropriate size may mean that form content could be reorganized into manageable tasks of data entry—possibly more appropriate for entry on a computing device.

Organizing form content as the sum of reasonably sized logical field groups 102 instead of a single conglomeration of all fields in one may allow form content capture to be completed in a series of smaller, disparate data entry sessions, which may be presented in a manner better suited to the limited viewing area and nature of a computing device. A systematic graphic layout of form content may be useful or even valuable in a paper form (or as a web page), but may also be a hindrance when presented on a computing device with limited viewing area and/or native interfaces potentially incongruent with the given graphic layout. logical field groups 102 are an organization of form content not for graphic layout, but for systematic flow of data entry.

The present inventor has identified that graphic layout of form content is potentially incongruent with ideal form content presentation and input data entry on a computing device. Described differently, the concept of a form template—meaning the organization of form content into an ideal graphic layout for a paper medium or a web page medium—is potentially an ineffective and even cumbersome approach of form content presentation and input data entry on a computing device having a limited viewing area and/or native interfaces. Organizing form content into logical field groups 102 eschews the need for graphic organization in favor of organizing for common data entry characteristics.

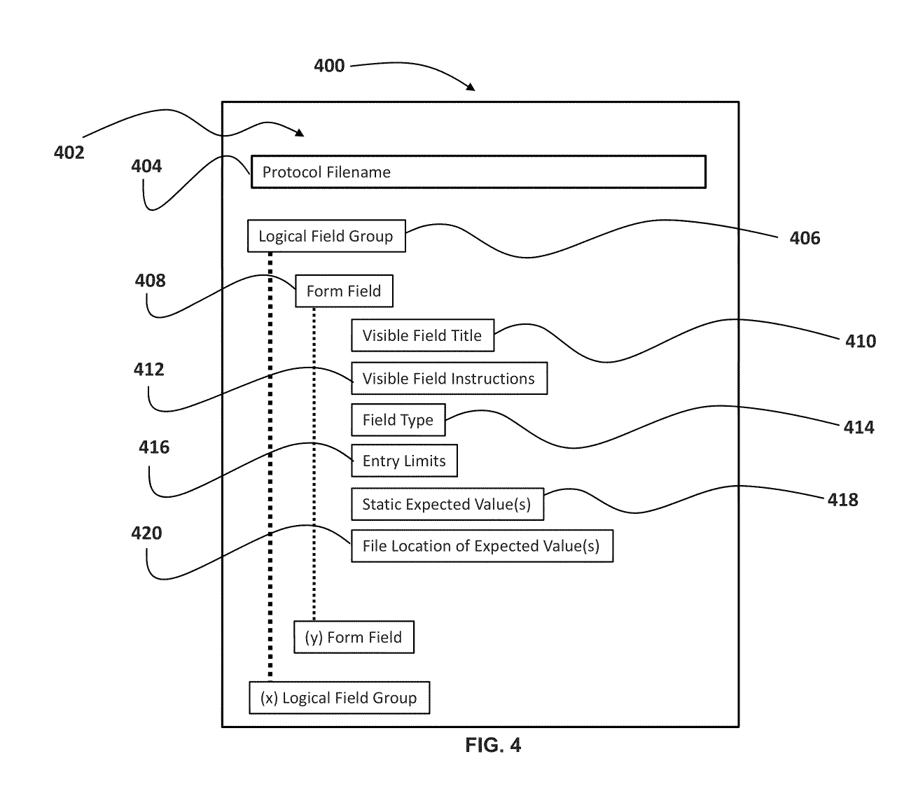

FIG. 4 is a data set representation 400 of one embodiment of form content referred to as a Form Content Definition File 402 or more succinctly referred to as a protocol 402. The protocol 402 may define one or more logical field groups 406. Each logical field group 406 may be an electronic data structure that includes one or more form fields 408, each having a plurality of characteristics or properties 410, 412, 414, 416, 418, and 420. A protocol 402 may replace a traditional form template (e.g., organization of form content into an ideal graphic layout for a paper medium or a web page medium), in favor of packaging multiple logical field groups 102 from the same form and/or organization process for improved (e.g., optimal) form content presentation and data entry on a computing device. A protocol 402 may also enable a standardized and packaged data set to exchange between form users on computing devices. A protocol 402 may be distinguished, for example, from form templates by an absence of an associated graphical layout. Protocols 402 may contain the form content for the scope of an entire organization process (or of an entire form) in a format that is flexible and compatible with a variety of computing devices and environments, and particularly mobile computing devices having a limited display area and/or native interfaces.

A protocol 402 may be an electronic data structure. A protocol 402 may have a unique filename 404. As illustrated in FIG. 4, protocols 402 may, within the electronic data structure, define a hierarchal structure with a first level being logical field groups 406, containing all the logical field groups 406 needed to serve an associate organization process up to (x) logical field groups 406. Within each logical field group 406, a second hierarchal level may be the form fields 408, including all fields in the given logical field group 406 up to (y) form fields 408.

For each Form Field 408 one or more field characteristics helpful (or needed) for eventual data entry may be provided, and might include, but are not limited to: Visible Field Title 410, a functional title to distinguish the field purpose to a form user; Visible Field Instructions 412, which may be included to assist a form user on how to complete the field; Field Type 414, which may be included to assist any data capture software to apply the correct capture logic for a text field, checkbox, radio button, or other field type; Entry Limits 416, which may be included to prevent capture of values unacceptable to the associated organization process; Static Expected Value(s) 418, which may be included as the values to be sought in capture which do not change or evolve over the ongoing conduct of the organization process; and File Location of Expected Value(s) 420, which may be included where the values to be sought in the capture process do change with the ongoing conduct of the business process and may be appropriately referenced via a separate, dynamic file at a known location for access. Other field and data characteristics may be included as part of a protocol 402 as needed by the organization process and/or data capture software on the computing device.

With form content organized into logical field groups 406 and/or protocols 402, a presentation of a system for collecting data, such as form data, on a computing device, according to one embodiment of the present disclosure, can now be accurately described.

### Form Content Creation, Distribution, Presentation, and Capture

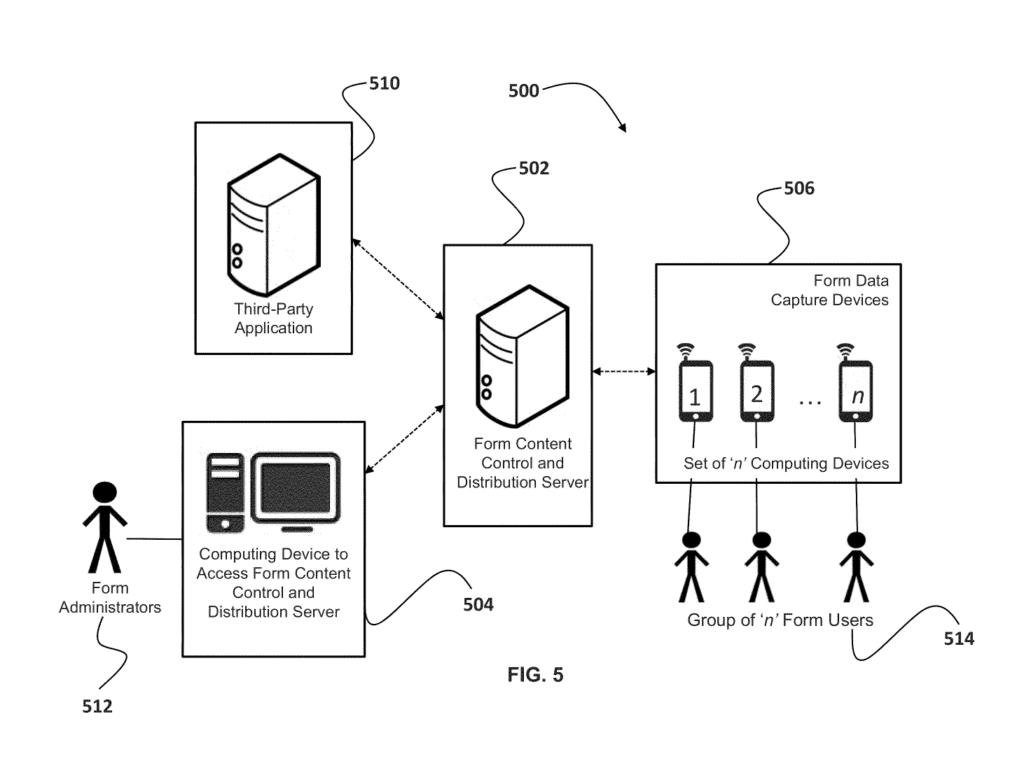

FIG. 5 is a system 500 for inputting data on a computing device according to one embodiment. The system 500 may enable creating, distributing, presenting, and capturing form content. The system 500 may include a Form Content Control and Distribution Server 502 which may be embodied in any suitable computer hardware, including, but not limited to, a server, a workstation, or another computing device. The system 500 may further include a computing device 504 to access the Form Content Control and Distribution Server 502. The computing device 504 may be embodied in a personal computer, laptop computer, tablet computer, handheld device, or smartphone. The system 500 may additionally include one or more form data capture devices 506, for example embodied as a set of ‘n’ (one or more) computing devices (e.g., mobile devices). The system 500 may include access to a third-party application 510, which, according to one embodiment, may be or otherwise facilitate an organization process that the form content serves, and as such, may host, among other possible functions, the historical results, ongoing conduct, rules, and management of a business process. An example of a third-party application 510 may be a home healthcare electronic medical records system, which may manage, record, execute, and/or archive, for example, the business process of admitting a patient. Other examples of potential third-party applications 510 may be a public utility company database of inspection results and a life insurance company customer relationship management (CRM) system.

FIG. 5 also shows the possibility of at least two possible actors using the system 500. First, form administrators 512 may use a computing device 504 to access the Form Content Control and Distribution Server 502 to conduct various possible tasks of form content creation, distribution, and management, among other possible tasks. The form administrators 512 may prepare, implement, and/or otherwise define protocols 402 (or Form Content Definition File 402) described above with reference to FIG. 4. A group of ‘n’ form users 514 may use or otherwise access a set of 1 to ‘n’ form data capture devices 506 to capture and manage various form content. Form administrators 512, according to one embodiment, may be considered responsible for implementing the system 500 and ensuring that the system 500 properly, consistently, and accurately captures desired or needed data for the business process, while form users 514 may be considered responsible for the ongoing actual capture of form data or input data which is intended to be provided (and gathered) as a result of form content. More detailed analysis and description of the system 500 and responsibilities of form administrators 512 and form users 514 follow below.

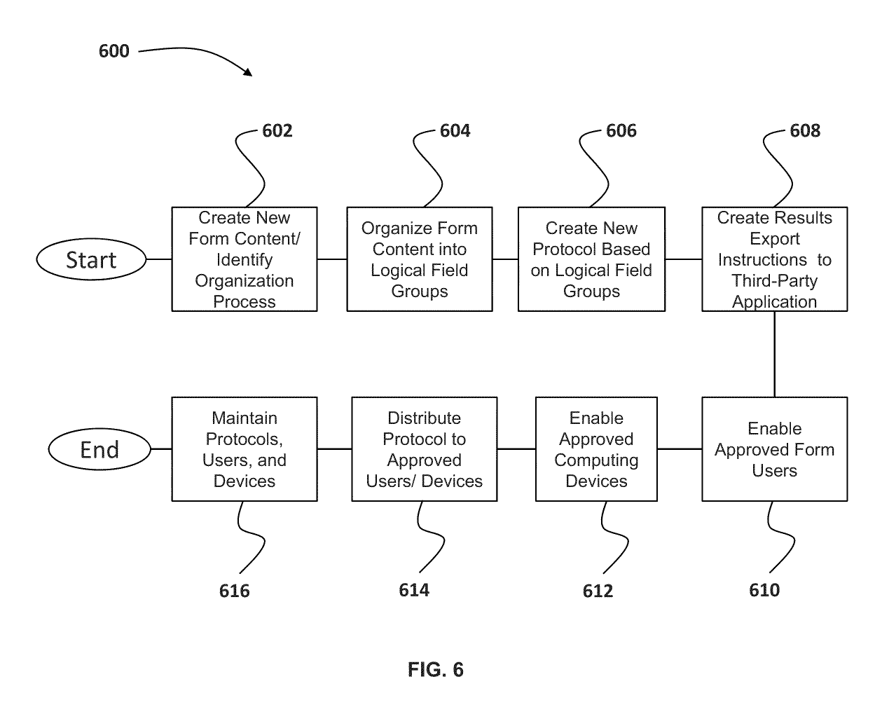

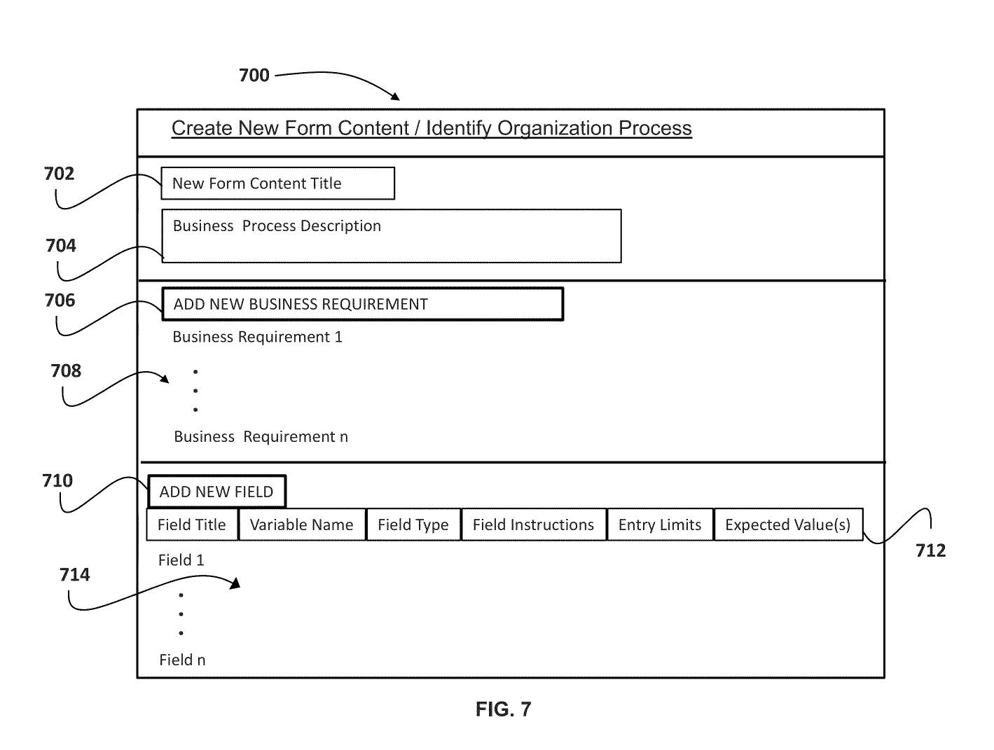

FIG. 6 is a flow diagram 600 of the form administrator's 512 potential capabilities, responsibilities, and/or use of the system 500. The flow diagram 600 may provide a summary of a method and/or a workflow. In the embodiment of FIG. 6, new form content is created 602, which may generally include identifying an organization process for which the form content is directed to gathering information. The form content may be organized 604 into logical field groups. A new protocol (or form content definition file) may be created 606. The new protocol that is created 606 may be based on and/or include the logical field groups. Instructions to export results to a third-party application are created 608. These instructions may define a format and/or manner by which input data entered into the form fields is packaged and/or delivered, for example, to a third-party application. Approved form users (of the new protocol) may be enabled 610, such that these approved users can access the protocol and/or form content to provide input data. Approved computing devices may be enabled 612 to receive or otherwise access the new protocol. The new protocol (or form content definition file) can be distributed 614 to the approved users and/or approved devices. The protocols, approved users, and approved devices can be maintained 616, including updating information. More details of the method of the flow diagram 600 are discussed below in greater depth, including with reference to FIGS. 7-9.

New form content may be created 602, for example by form administrators 512 (see FIG. 5). Form administrators 512 may generally work on the Form Content Control and Distribution Server 502 of FIG. 5, via, for example, a remote computing device 504 to access the Form Content Control and Distribution Server 502. A form administrator 512 may receive a request to convert an existing form (e.g., a form in a paper medium) for use in the system 500, or they may receive a request to create new form content for the system 500 based on a known business process, or they may receive some possible combination of the two. Either way, the form administrator 512 may create 602 new form content and/or identify an organization process. The system 500 may allow creation of new form content and/or identifying an organization process at will. Form administrators 512 may use their understanding of the business process, existing form templates, and other assistive possible queries in the system to populate the data needed for each new Form Content/Identify Business Process 602 that they may choose to create.

FIG. 7 is an interface 700, according to one embodiment, to create 602 new form content and/or to identify an organization process. FIG. 7 also represents and/or depicts details of a possible workflow. When creating new form content, a first step in the interface 700 may be to prompt the form administrator 512 (see FIG. 5) to title 702 the new form content and to describe 704 the organization process it serves in the appropriate text entry boxes. In the illustrated embodiment, the organization process may be a business process. This step may serve as a guide to future steps of building logical field groups 406 and protocols 402. Defining the problem may set a path toward a solution.

Once the business process is defined, the form administrator 512 can then add new business requirements by using an add new business requirement input component 706 of the interface 700. Form administrators 512 may continue to add business requirements until all desired business requirements of the business process are added. The interface 700 may present a listing 708 of added business requirements. As stated before, the term “business requirement” refers to one of various classes of information, data, confirmation, analysis, and/or other results that may be needed to fulfill a given business process. For each new business requirement, a corresponding logical field group 406 (see FIG. 4) may be established, further defining the new form content created in the workflow.

The desired or needed fields are entered into the interface 700 by the form administrator 512 (FIG. 5) by using the Add New Field input component 710. Often the form administrator 512 may have an existing paper form template when creating new form content, which may assist with entering the desired, needed, or otherwise appropriate fields. If not, the previously created list of business requirements 708 can assist to brainstorm and identify desired, needed, or otherwise appropriate fields. For each field, field properties 712 may be entered including, but not limited to, field title, variable name (e.g., in the third-party application 510 of FIG. 5), field type (e.g., text, checkbox, etc.), field instructions for entry, entry limits, and expected value(s). These properties may be used later by the form data capture devices 506 to accurately and efficiently capture field data. For example, these properties may be used to optimize display or rendering of a user interface presenting the field to a user. As desired fields for the business process are entered into the interface 700, a listing of the fields 714 may be presented and be viewable in the interface 700. Creating 602 new form content and/or identifying a business process may be completed once all desired fields are entered.

Returning to FIG. 6, form administrators 512 may organize 604 form content into logical field groups 406 to serve the identified business process and to organize form fields. This step may be accomplished in accordance with the methods for organizing form content into logical field groups and/or refining logical field groups shown in FIGS. 2 and 3 and described above with reference to the same, where logical field groups 406 were first discussed.

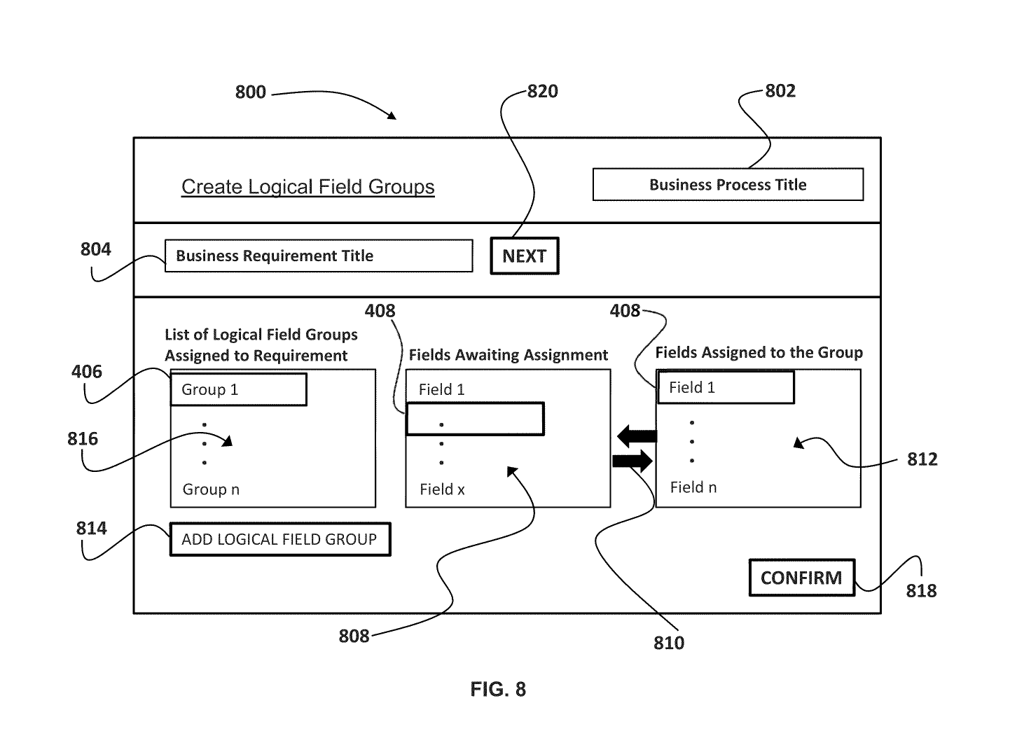

FIG. 8 is an interface 800, according to one embodiment, to accomplish these tasks to organize 604 form content into logical field groups 406. FIG. 8 also represents and/or depicts the details of a possible workflow. The interface 800 to organize 604 form content into logical field groups 406 may include the business process title 802 as a guide, and may present the first business requirement title 804. All of the fields created in the interface 700 and possible workflow to create 602 new form content and/or to identify a business process are shown initially in the area Fields Awaiting Assignment 808, which may present as a full scope of fields for use in the interface 800. A listing of logical field groups 406 (that were created using the interface 700) for the given business requirement 804 is shown initially in the area List of Logical Field Groups Assigned to Requirement 816. Using the arrows 810, form administrators 512 can move fields into the logical field group 606 field assignment area 812 and out of the list of remaining fields 408 awaiting assignment in a fields awaiting assignment area 808 of the interface 800. In the illustrated embodiment of FIG. 8, a field 408 may be assigned to one logical field group 406, such that once the assignment is confirmed into a logical field group 406, the field 408 is removed from the list in the fields awaiting assignment area 808. In other embodiments, a field 408 may be assigned to a plurality of logical field groups 406.

As outlined in FIG. 3 and described above with reference to the same, it may be desirable for logical field groups 406 to be a reasonable size. If a logical field group 102 is too large to be reasonable, the interface 800 may issue a warning. In such a case a form administrator 512 can select the Add Logical Field Group 814 input component and a new logical field group will appear in the list of logical field groups 816. Toggling between logical field groups and using the arrows 810, fields can be placed in the correct logical field group 406. Form administrators 512 can use the confirm 818 button to save the field assignments. Once the needed or appropriate logical field groups 406 are completed for the given business requirement, form administrators 512 can advance to other business requirements using the next 820 button to complete the task of organizing 604 form content into needed logical field groups 406 for each business requirement, repeating the workflow described above until needed logical field groups 406 are defined and the desired fields 408 are assigned.

In other embodiments, the fields 408 may be assigned to a logical field group 406 at a time of creation. In other words, fields 408 for a selected logical field group 406 (or a specified business requirement) may be created specifically for that logical field group 406. As such, a separate task of assigning fields 408 to logical field groups 406, or otherwise organizing form content into logical field groups, may be unnecessary. This task may be accomplished at or combined with creation of form content.

Turning back to FIG. 6, form administrators 512 may then create 606 new protocol 402 (see FIG. 4) (or Form Content Definition File 402) to include the logical field groups 406. This may be accomplished in accordance with the conceptual description for protocols 402 shown in FIG. 4, and described above with reference to the same. FIG. 4 shows one embodiment of a structure under which a protocol may be stored in the system 500 of FIG. 5. A task for the form administrator 512, since all other data may be in the system 500 from accomplishing previous tasks, may be to save the data under a name that will be recognized and understood by form users 514.

For each protocol 402, form administrators 512 may also create 608 results export instructions to a third-party application 510. These export instructions may remain as a persistent, although editable, property of the protocol 402. That means that protocols 402 not only contain form content as shown in FIG. 4, but may also include internal instructions for the form data capture devices 506 to eventually export form data and/or form instances (e.g., form content with form data) to the third-party application 510. Instructions may include, but are not limited to, protocols of communication, security, confirmation, and error handling. Pre-defined export instructions in the protocol 402 may relieve form users 514 from needing to manually route the transfer of their captured form content to the third-party application 510.

In the flow diagram 600 of FIG. 6, once the definition and organization of form content have been completed, form administrators 512 can configure the distribution of form content. Form administrators 512, again using the Form Content Control and Distribution Server 502, may enable 610 approved form users and enable 612 approved computing devices. Form administrators 512 may control who receives form content by both user ID and/or computing device ID.

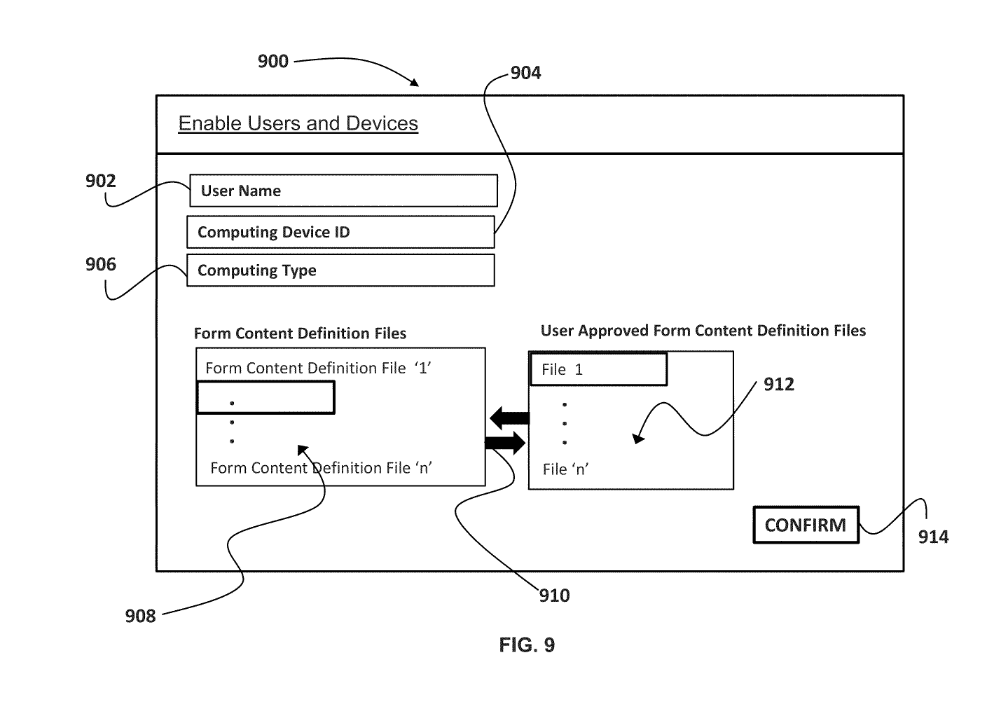

FIG. 9 is an interface 900, according to one embodiment, to accomplish these tasks of authorizing or enabling 610 approved form users and authorizing or enabling 612 approved computing devices. For each new user, form administrators 512 can enter a user name 902, computing device ID 904, and computing device type 906. A list 908 of protocols 402 is provided. By selecting a listed protocol 402 and using the arrows 910, form administrators 512 can add approved 912 protocols 402 to the given user. Information can be saved using the confirm 914 button.

Referring again to FIG. 6, with approved form users 514 enabled 610 and/or approved computing devices enabled 612 and protocols 402 created 606, form administrators 512 may then distribute 614 protocols 402 to approved users or devices. This may be done for all form users 514 in one step, for one form user 514 at a time, or some combination of the two. Distributing 614 a protocol 402 to the form user 514 may allow the form user 514 to begin capturing form content at will, for example, via a form data capture device 506.

Form administrators 512 may also maintain 616 protocols 402, users, and devices, among other possible tasks, including, but not limited to, editing, deleting, extending, adding, and removing form content and approved users/devices. The workflow of the flow diagram 600 allows form content and approved form users to be managed centrally, in a secure IT environment, in a point of control that form users 514 may not be able to disrupt and/or by which form users 514 need not be burdened. The workflow of the flow diagram 600 and/or a centrally managed point of control may also put a minimal amount of burden on the form data capture devices 506, which may have a limited viewable area, processor, or memory, and may keep complex management on a server or other more robust computer equipment. As can be appreciated, in other embodiments a more distributed workflow and/or configuration may be employed, such that maintenance and/or increased processing may occur on one or more form data capture devices 506.

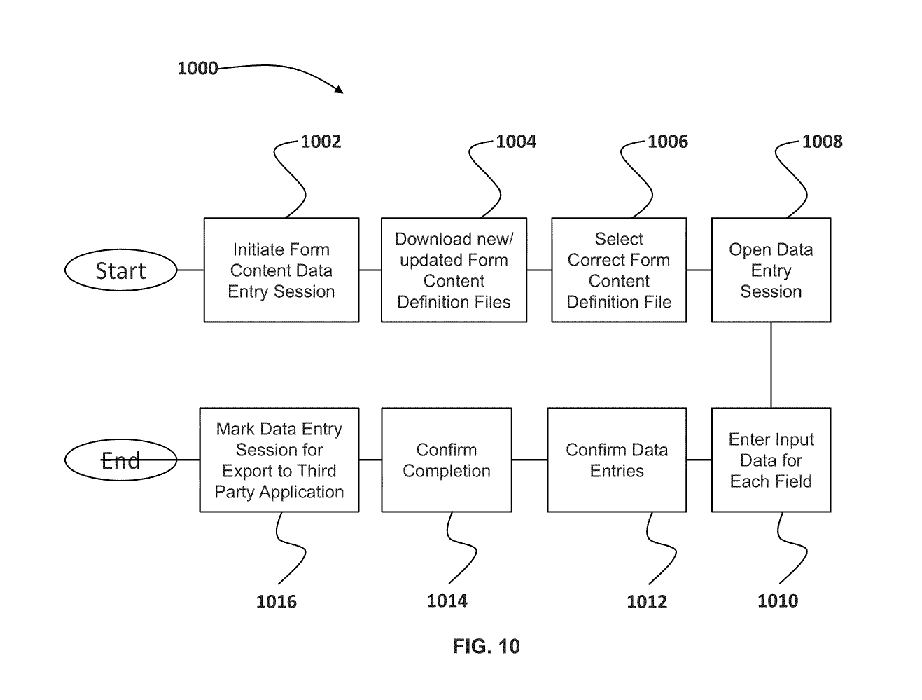

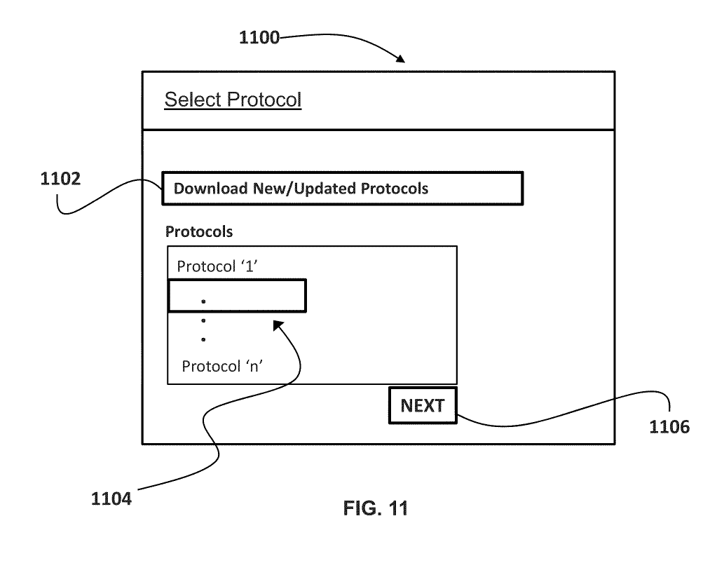

Turning now from form administrator 512 capabilities and/or responsibilities to those of the form user 514, FIG. 10 is a flow diagram 1000 of a form user's 514 capabilities, responsibilities, and/or use of the system 500 of FIG. 5. The flow diagram 1000 provides a summary of a workflow, according to one embodiment. Form users 514, except where specifically noted, conduct the workflow 1000 entirely on their given form data capture device 506 using input data entry modules and/or interfaces on the form data capture device 506. Form content data entry modules and/or interfaces may comprise software, hardware, or a combination thereof. In the embodiment of FIG. 10, a data entry session may be initiated 1002, during which a user may provide form data using input fields of logical field groups and/or protocols. New or updated protocols may be downloaded 1004 and an appropriate protocol may be selected 1006. A new data entry session or a previously initiated data entry session may be opened 1008. Form data, for example in the way of user input, may be entered 1010 for each field. The entered user input may be confirmed 1012 (e.g., for accuracy, correct form, and/or the like). In this manner, user input may be entered 1010 and confirmed 1012 as the user continues through all logical field groups. Completion of user input for all fields of all logical field groups may be confirmed 1014 and the form data collected for the data entry session may be marked 1016 for export to a third-party application. More details of the method of the flow diagram 1000 are discussed below in greater depth, including with reference to FIGS. 11-21.

A data entry session may be initiated 1002, for example, by form users 514 (see FIG. 5) on a form data capture device 506 (e.g., a computing device). The specific manner to initiate may depend on the computing device and its operating system. As part of the initiation 1002 of a data entry session the form user 514 may be authenticated by the Form Content Control and Distribution Server 502 as an approved user and/or approved computing device. If so authenticated as an approved user, a form user 514 may be enabled to download 1004 (or otherwise receive) new and/or updated protocols 402 to their form data capture device 506.

The protocols 402 may be stored locally on the form data capture device 506 memory so that they can be used at will by form users 514 without needing to download anew each time they are used. The protocols 402 may also be intended to be downloaded 1004 to allow offline use of the form data capture device 506. Form users 514 may select 1006 a correct or desired protocol 402 based on the organization process for which they are assigned to capture form content. Downloaded protocols 402 can be reused multiple times in a potentially unlimited number of data entry sessions.

FIG. 11 is an interface 1100, according to one embodiment, to accomplish the tasks of downloading new and/or updated protocols 402 and selecting 1006 a particular protocol 402. Form users 514 may first opt to select a download new and/or updated protocols input component 1102 if they choose to query the Form Content Control and Distribution Server 502 (see FIG. 5) for newly approved and/or updated protocols 402. The request may require an active data connection. This action may be optional and is not required to proceed.

Form users 514 may, again in the interface 1100 of FIG. 11, scroll through a list 1104 of downloaded protocols 402 and select 1006 a desired protocol 402, for example, by actuating the “next” input component 1106 (e.g., button). Selecting 1006 an appropriate protocol 402 may not require an active data connection with the Form Content Control and Distribution Server 502 since the list 1104 may reflect protocols 402 previously downloaded to the form data capture device 506. In the embodiment of FIG. 10, with the selection 1006 of the correct protocol 402, a data entry session may be opened 1008.

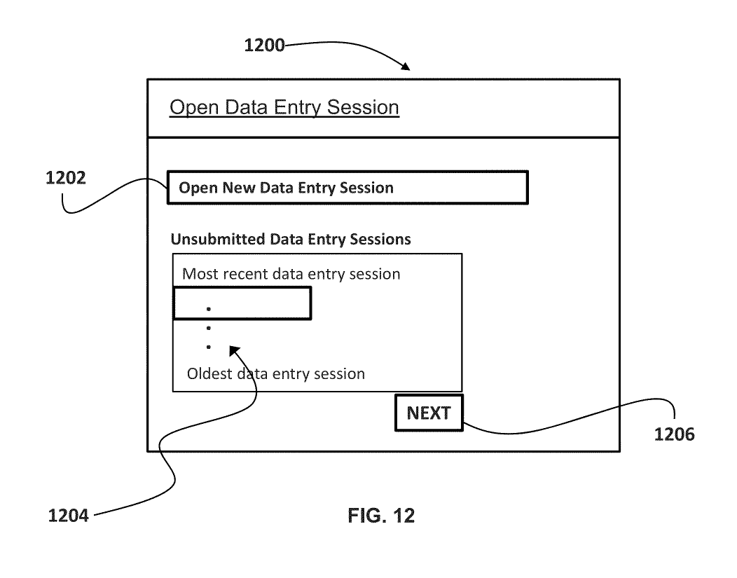

FIG. 12 is an interface 1200, according to one embodiment, to open 1008 a data entry session. Form users 514 may choose to open a new data entry session input component 1202 to open 1008 a new data entry session. A new content data entry session may begin with a first logical field group 406. Alternatively, a user may choose to open 1008 (or re-open) a previous data entry session from a list 1204 of unsubmitted data entry sessions by selecting a data entry session from the list 1204 and actuating a “‘next” input component 1206. Circumstances may not always allow complete data entry sessions and so form users 514 may need an option to save their work (e.g., as a data entry session) and open 1008 (e.g., re-open) it later when circumstances allow its completion. Upon opening 1008 a data entry session, form users 514 may be presented with an overview of the purpose, instructions, or guidelines for entry of data for a given logical field group 406 to orient the user to and provide context for the proper entry of data. Form users 514 may be presented with a field to receive input data entry for the first logical field group 406 or a next field needing entry from a previous data entry session.

User input may be entered 1010 or otherwise provided for each field. Given that the interactive/viewable area of some computing devices may be small, a traditional approach of completing a paper form in a continuous process, moving at will from field to field within a larger form layout, might not be feasible or possible on all computing devices. Some computing devices, such as handheld devices, may only reasonably allow entry of a single field at a time. The system 500 may anticipate entry of fields one by one, to accommodate possible limitations of a computing device. Presentation of a single field at a time, and user input being provided to a single field at a time (e.g., individual fields in a one-by-one serial manner) may resolve concerns of form data entry in small interactive/viewable areas. Presenting a single field at a time may negate a concept of a form “layout” and can embrace instead the earlier defined form content organization of logical field groups 406, which groups fields according to common characteristics so they might be presented to a potential form user 514 one by one in a logical sequence.

Advantages of entering fields one by one, as made possible by the disclosed embodiments, are not limited to small interactive/viewable areas. Many computing devices are used outdoors, in possible bright sunlight, which can make it difficult on some computing devices to recognize anything in the interactive/viewable area except the largest and brightest user interface components. Also, some computing devices lack the resolution to show minute details of fields and/or instructions to complete them. Both of these possible limitations can be addressed by the simpler approach of the disclosed interfaces, namely an approach of entering fields one by one.

The disclosed embodiments can avoid using the otherwise popular mobile computing device interface of “zooming” in and out and/or scrolling through a larger interface that could be implemented to possibly interact with a multitude of form fields at the same time. Form users 514, working within the demands of a business process they serve, may value speed and ease of use. Form users 514 may complete a multitude of fields faster by entering all fields one by one (as they are automatically presented, one by one, in series on the user interface), without a need to “zoom” or “scroll” in between the act of entry of each field.

To further define the possible action of entering each field one by one, a possible interface will next be described for each classical form field type including: radio buttons, checkboxes, and text fields. Any and/or all of these possible interfaces, and other appropriate interfaces, may be used as a form user 514 enters 1010 input data for each field. Each of the disclosed interfaces may minimize required interaction points of a form user 514. One example is the interfaces may combine the tasks of entering data, confirming its correctness, saving for later use, and/or advancing (e.g., opting to move) to the next field into a user single action. This may be accomplished by presenting a “likely value” for input to a given field in the interactive area and allowing the form user 514 to directly select the likely value, expressly confirming it is a correct value based on the direct selection, identifying the input for submission, and/or causing advancement to the next field for entry—all in one selection (or manipulation of the interface). In other words, a single input may direct or effectuate a plurality of actions. In another embodiment, one of the plurality of actions may be actual submission of the value confirmed and identified for submission. In another embodiment, confirmation of the input data and advancing to a next field may be accomplished by a single confirmation input action. Confirmation of the input data may include a user confirming the input data is correct. Confirmation of the input data may include confirming the input data has a correct form for the given field.

As defined previously, form fields may be found in a variety of standard types, including, but not limited to, radio buttons, checkboxes, and text fields. Given some of the possible limitations of computing devices described above, input data entry may be enhanced by a unique interface for each field type. In other words, optimization of the user interface, based on the field type and/or properties of the field, may be desired.

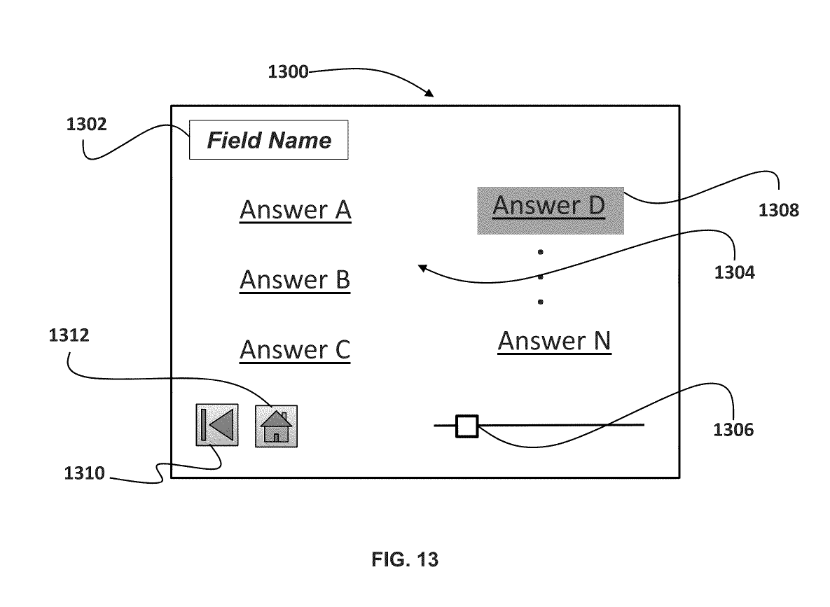

FIG. 13 is an interface 1300, according to one embodiment, that may be optimized to enable input data entry for radio button field types where a variety of pre-defined values are presented and one and only value may be selected. The interface 1300 may include a Field Name 1302, which is presented as a possible guide to the form user 514 to know the desired response for the field. Optionally, the interface 1300 may also include a field description (e.g., an inquiry) to describe the input being collected or requested. All of the pre-defined values (e.g., answers or responses) are presented in a list 1304. In the case of the radio button interface 1300, the “likely values” were pre-set when the logical field group 406 was first created (see data set representation 400 of FIG. 4). If all values cannot be efficiently presented on a single screen view, a sliding bar 1306 may be provided to facilitate scrolling through all options.

Each pre-defined value in the list 1304 may be active buttons themselves and selecting one, as shown by example in FIG. 13 with “Answer D” 1308, may both select and confirm the value for data entry, and may also advance the user automatically to the next field for entry. Again by way of example in FIG. 13, if a form user 514 were to so select “Answer D” 1308, “Answer D” 1308 would be confirmed as the desired value for the Field Name 1302, “Answer D” 1308 would be saved for submission with the Field Name 1302, and the form user 514 would immediately be presented with a next field interface for data entry of user input to a next field in the logical field group. If a mistake was made, and the form user 514 actually intended a different value than “Answer D” 1308, the field entry interface may include a back button 1310 that may allow the form user 514 to override the automatic advancement, and return to the original interface with a fresh opportunity to select the correct value. Additionally, each input data entry interface may include a home button 1312 to exit the data entry session.

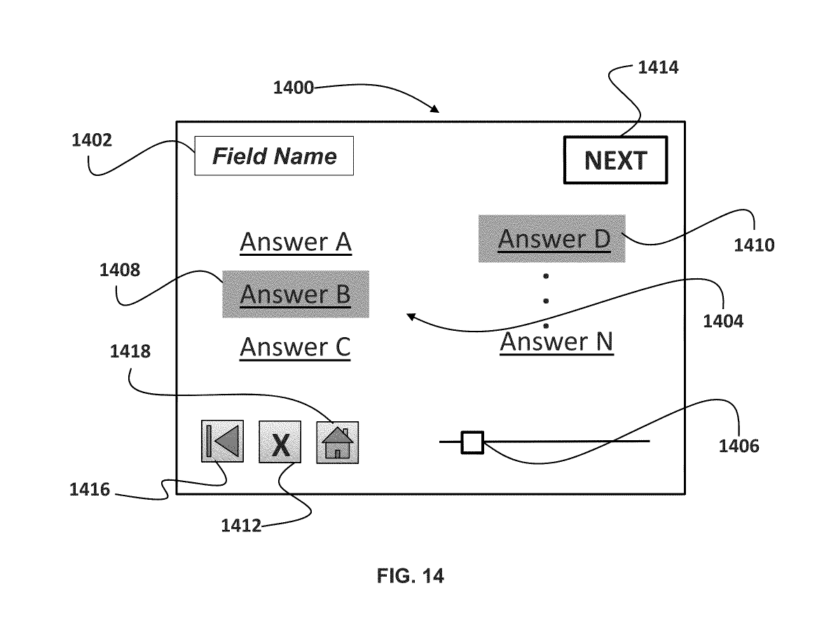

FIG. 14 is an interface 1400, according to one embodiment, that may be optimized to enable data input for checkbox field types where a variety of pre-defined values are presented and one or several values may be selected. The interface 1400 in FIG. 14 is similar to the interface 1300 in FIG. 13, except that checkboxes, different from radio buttons, allow selection of multiple values. As such, an additional step of confirmation may be included or required in the interface 1400 that may allow for confirmation of multiple possible values. The Field Name 1402 may be presented as a possible guide to the form user 514 for context to know the desired response(s) for the field. Optionally a field description (e.g., an inquiry) may be included to describe the type of information (e.g., input data) being requested and collected. All of the pre-defined values (e.g., answers or responses) are presented in a list 1404. In the case of checkboxes, the “likely values” may have been pre-set when the logical field group 406 was first created (see data set representation 400 of FIG. 4 and discussion of same). If all values cannot be efficiently presented on a single screen view, a sliding bar 1406 may be provided to facilitate scrolling through all options.

Form users 514 may select one or multiple pre-defined values by selecting the desired pre-defined values. In FIG. 14, “Answer B” 1408 and “Answer D” 1410 are shown as being selected as an example of input data entry into the interface 1400. To unselect or to clear all selections, the form user 514 may use a delete icon 1412 which may be provided and which may undo any and all pre-defined value selections. To confirm the selections and automatically advance to the next field for entry, the form user 514 may provide a confirmation action, such as use the next button 1414 or swiping across the screen (e.g., from right to left). In a checkbox field, which may have multiple correct values, a next button 1414 may be desired or needed to accommodate the multiple possible correct values. Again by way of example in FIG. 14, if a form user 514 were to so select “Answer B” 1408 and “Answer D” 1410, and then select “next,” “Answer B” 1408 and “Answer D” 1410 would be confirmed as the desired value for the Field Name 1402, “Answer B” 1408 and “Answer D” 1410 would be saved for submission with the Field Name 1402, and the form user 514 would immediately be presented with the next field interface for data entry. If a mistake was made, and the form user 514 actually intended a different value than “Answer B” 1408 and “Answer D” 1410, the field entry interface may include a back button 1416 that may allow the form user 514 to override the automatic advancement, and return to the original interface with a fresh opportunity to select the correct value(s). Additionally, each field entry interface may include a home button 1418 to exit the data entry session.

In another embodiment, the user may confirm and advance by simply swiping across the touch screen of the computing device. In such embodiment, a next button 1414 or other input component may not be needed. Similarly, the home button may not be needed, because a user may be able to navigate back by swiping a touch screen in an opposite direction. For example, confirming and advancing may be accomplished by a swipe from right to left across the touchscreen and navigating back (e.g., to correct input data) may be accomplished by a swipe from left to right across the touchscreen.

Text fields, unlike radio button fields and checkbox fields, are notoriously more difficult to correctly capture in forms because of the challenge to interpret handwriting of a diversity of form users 514. Automated interpretation of handwriting is almost impossible to perfect, but can be enhanced by limiting interpretation to “likely values”—the scope of characters and/or whole words which would be entered in a given field. An example is trying to interpret a “5” compared to an “S”. If it is known in advance that the “likely values” for the field are numeric only, such as a field capturing a Zip Code, any shape with the appearance of an “S” or a “5” is by definition a “5” in the example. The concept is not just characters; it can also be whole words. An example might be a field that captures a product number. The interpretation could be limited to a pre-set list of part numbers that seeks to make the best match, not necessarily each and every single character. “Likely values” are given for definition in preparing for the below presentation of possible interfaces for text field entry.

For text fields, three different varieties of possible interfaces may be presented. Each may be differentiated by their respective “likely values” for data entry. Their definitions will be described first, then the possible interfaces. The first is “Text Entry, No Expected Value,” where individual letters may be limited to a certain character set, but there is no limit to the possible data values for the field. Examples on a form may include, but are not limited to, name, address, or telephone number. Each might be limited to a certain character set (name as example is alpha-only and telephone is numeric-only), but the data values for the field as a whole are virtually limitless. Interpretation of each character may aid in interpreting the data value for the field. In paper forms, this type of field often uses letterboxes to encourage form users 514 to write characters individually in hopes of easier interpretation.

The second is “Text Entry, Pre-Set Expected Values,” where there is a pre-defined set of possible data values for the field. Examples might include, but are not limited to, a field to write a doctor's name among the doctors working in a specific hospital, a field to write a part number among the possible part numbers in a specific inventory, or a U.S. state among the 50 U.S. states. In this field type the goal is to make the most accurate match to the pre-defined set of possible data values for the field—not to interpret each individual character perfectly. It is possible to think of this text field type as similar in function to that of a radio button field, but its necessity is usually because the list of pre-defined set of possible data values is too large to be effectively represented graphically and is easier to write.

The third is “Free Text,” where there is no limit to the “likely values” of text—and no limit to the number of text values that may be strung together to make the complete data value for the field. Examples of this field type may include, but are not limited to, a “comments” or a “notes” field where anything may be written and the number of words and/or numbers is variable. This can usually be a more difficult field type for form content capture technologies since there is no limit to the scope and length of the expected text values and no “likely values.”

One more concept before presenting the possible interfaces for entry of text field types is to consider the possible ways text and/or characters may be entered into a computing device. The first reaction to enter text form data may be to use a keyboard, but some computing devices do not have a physical keyboard. Some computing devices use a “virtual” keyboard (e.g., a touchscreen keyboard) that is presented in the interactive area of the computing device. Virtual keyboards, common in smartphones, can be difficult to use and often reduce the already limited interactive/viewable area. The system 500 may still allow keyboard entry, both physical and virtual, if the preference is indicated by the form user 514. The system 500 may also allow other possible interfaces to enter text form data as made possible by the given computing device. There is no limit to the possible ways to capture text form data on a computing device, but the focus of the system 500 is voice recognition for text form data. A voice recognition input component may be a potential alternative to keyboards in certain computing devices, and it may remove the limits of small interactive/viewable areas, external environment, and uncomfortably small keyboards with an entry method that does not depend on the size of the interactive area. The specifics of voice recognition and its application in the system 500 are presented below. The disclosure will now describe the possible interfaces using voice recognition.

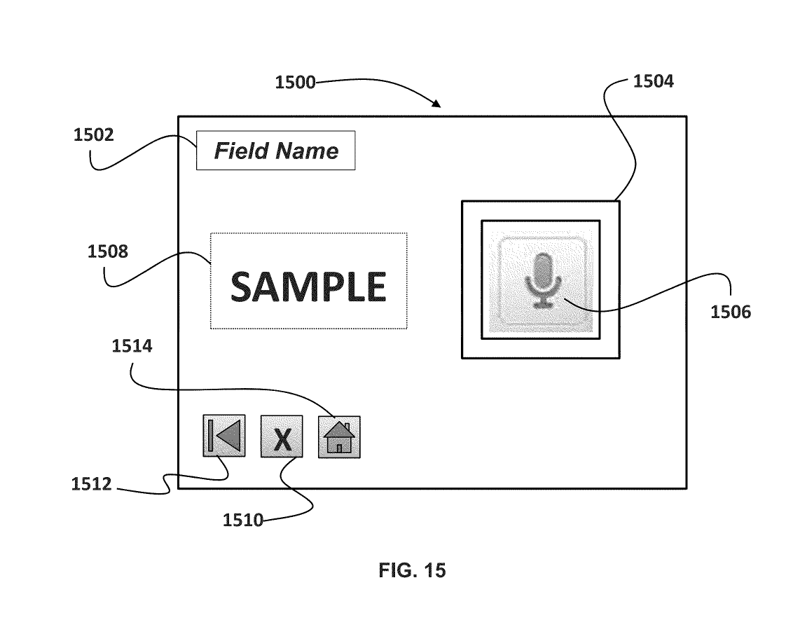

FIG. 15 is a text field entry interface 1500, according to one embodiment, optimized to enter input data into a text field of a type described above as “Text Entry, No Expected Values.” The Field Name 1502 is presented as a possible guide to the form user 514 to know the desired response for the field. Optionally a field description (e.g., an inquiry) may be included to describe the type of information (e.g., input data) being requested and collected. Once the interface is presented, voice recognition may be automatically activated and ready to receive entry. The status of voice recognition may be indicated by a color outline 1504, green for on and red for stopped, for example. A form user 514 desiring to stop the voice recognition may do so by touching the voice recognition icon 1506, which may toggle the activation of the voice recognition. Toggling the voice recognition may allow the form user 514 to at any time pause their input data entry.

With the voice recognition active, the form user 514 may begin to spell the input data, character by character. As the voice recognition works, the recognized characters may be presented individually in real-time or as a whole at some point following recognition in the recognition presentation area 1508. In the example of FIG. 15, a form user 514 has spelled the word “sample” as “S-A-M-P-L-E” and it has been so recognized by the voice recognition and is now presented in the recognition presentation area 1508. The recognition presentation area 1508 may also be an active area in the interface 1500 allowing the form user 514 to both select and confirm the value for submission. In the case of FIG. 15, touching the active area may result in confirming “SAMPLE” as the intended input data for the field. In other embodiments, another confirmation action, such as using a next button or swiping across the screen (e.g., from right to left) may result in confirming the input data. If there has been an error in the voice recognition, the form user 514 can select the delete button 1510, and thereby delete the values in the recognition presentation area 1508 and restart input data entry for the field.

As with other interfaces, selecting and confirming the data value may also advance the user automatically to the next field for entry. If a mistake was made and the form user 514 actually intended a different value than “SAMPLE” 1508, the interface 1500 may include a back button 1512 that may allow the form user 514 to override the automatic advancement, and return to the original interface with a fresh opportunity to enter the correct value. Additionally, each interface may include a home button 1514 to exit the data entry session.

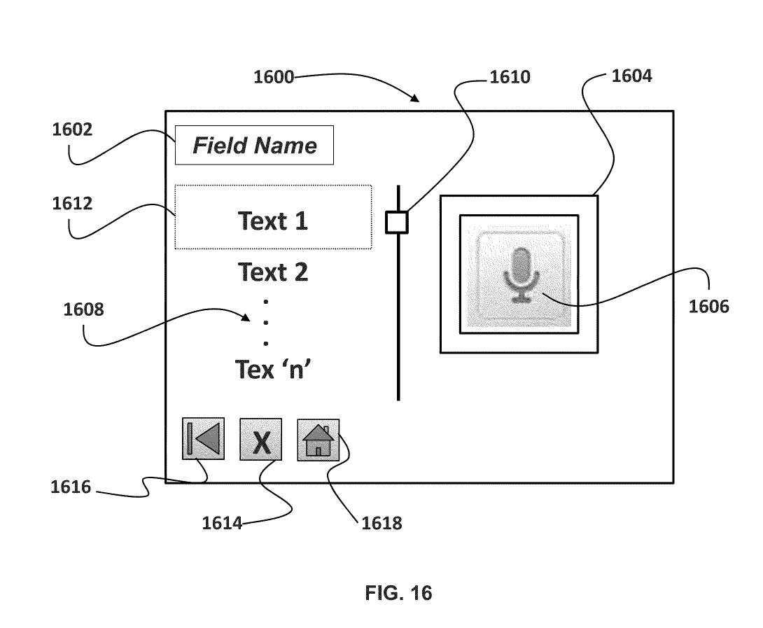

FIG. 16 is a text field entry interface 1600, according to another embodiment, to enter data into a text field of a type described above as “Text Entry, Pre-Set Expected Values.” The Field Name 1602 is presented as a possible guide to the form user 514 to know the desired response for the field. Optionally a field description (e.g., an inquiry) may be included to describe the type of information (e.g., input data) being requested and collected. Once the interface is presented, voice recognition may be automatically activated and ready to receive entry. The status of voice recognition may be indicated by a color outline 1604, green for on and red for stopped, for example. If a form user 514 wishes to stop the voice recognition, they may so select by touching the voice recognition icon 1606 which may toggle the activation of the voice recognition allowing the form user 514 to at any time to pause their input data entry. With the voice recognition active, the form user 514 begins to spell the field data value, character by character.

The expected data values for the field may have been pre-set when the logical field group 406 was first created (see data set representation 400). As the voice recognition interprets the first character and onward, an increasingly shorter list of possible matches from the expected data values may be presented based on the voice recognition results in a list 1608 in the interface. If the matches cannot be efficiently presented on a single screen view, a sliding bar 1610 may be provided to scroll through the matches. With the first character interpreted, the list could still be long if reduced at all. With each interpreted character the sub-set of possible expected values may be reduced. It is not expected that the form user 514 will need to spell out the entire entry and will likely select and confirm the desired input data once it is visible as an expected value in the interface 1600. Each matched expected value in the list 1608 may be active buttons themselves and selecting one, as shown by example in FIG. 16 with “Text 1” 1612, may both select and confirm the value as input data for submission, and may also advance the user automatically to the next field for entry. Again by way of example in FIG. 16, if a form user 514 were to so select “Text 1” 1612, “Text 1” 1612 may be confirmed as the desired value for input data for the Field Name 1602, “Text 1” 1612 may be saved for submission with the Field Name 1602, and the form user 514 may immediately be presented with the next field entry interface for data entry. In other embodiments, providing another confirmation action, such as using a next button or swiping across the screen (e.g., from right to left) may confirm the input and automatically advance the interface 1600 to the next field. If there has been an error in the voice recognition, the form user 514 can select the delete button 1614, and thereby remove all matches from the list 1608 and restart entry.

If a mistake was made, and the form user 514 actually intended a different value from “Text 1” 1612 as user input data, the interface may include a back button 1616 that may allow the form user 514 to override the automatic advancement, and return to the original interface with a fresh opportunity to enter the correct input data. Additionally, each interface includes a home button 1618 to exit the data entry session.

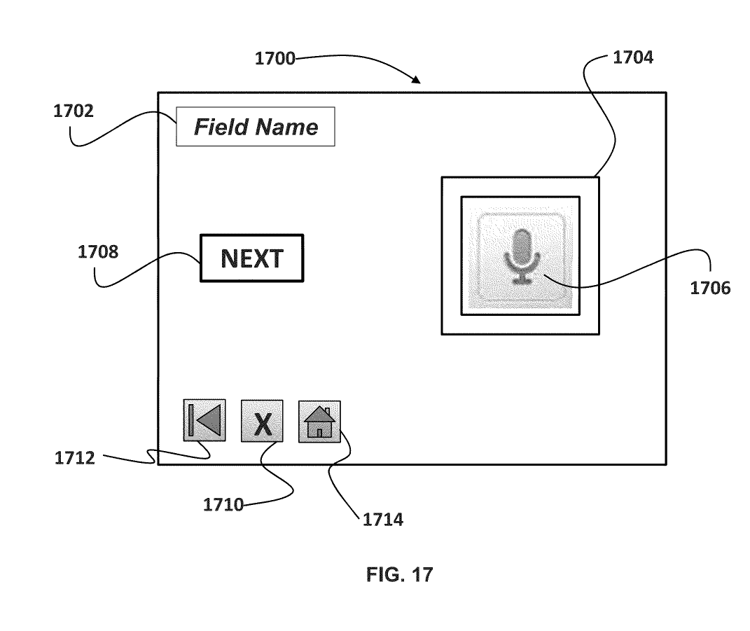

FIG. 17 is a text field entry interface 1700, according to still another embodiment, to enter input data into a text field described above as “Free Text.” The Field Name 1702 is presented as a possible guide to the form user 514 to understand the desired response or type of entry for the field. Optionally a field description (e.g., an inquiry) may be included to describe the type of information (e.g., input data) being requested and collected. Once the interface is presented, voice recognition may be automatically activated and ready to receive entry. The status of voice recognition may be indicated by a color outline 1704, green for on and red for stopped for example. If a form user 514 wishes to stop the voice recognition, they may so select by touching the voice recognition icon 1706 which may toggle the activation of the voice recognition allowing the form user 514 to at any time pause their input data entry. With the voice recognition active, the form user 514 begins to speak the input data in whole words. When the input data has been completed, the form user 514 may select the next button 1708 to indicate the full input data for the field has been spoken and to automatically advance the interface to the next field for entry. Given the small interactive area, it may not be possible to show the entire input data for a free text field entry and, worse, editing may be even more difficult. The interface 1700 may expect the input data for free text will be “blindly” submitted to the backend. The interface may also be adjusted to allow confirmation and/or editing.

If there has been an error in the speaking, the form user 514 can select the delete button 1710, clearing the voice recognition for the field and restarting entry. If a mistake was made, the interface 1700 includes a back button 1712 that may allow the form user 514 to override the automatic advancement, and return to the original interface with a fresh opportunity to enter the correct value. Additionally, each interface includes a home button 1714 to exit the data entry session.

Each of the interfaces above for input data entry may be used by the system 500 to interpret entry input data into fields to provide field data values—the intended data values that may later be submitted to the ongoing business process. For radio button and checkbox field types, as presented, the selection of the value(s) serves as the interpretation of the field data value. For text field types, a separate character and/or voice recognition process may be implemented, among other possible approaches to interpret text entry, inside the system 500 to interpret the entry into field data values. Correct interpretation of entry into intended field data values may be important to the business process enough to justify verification before submission.

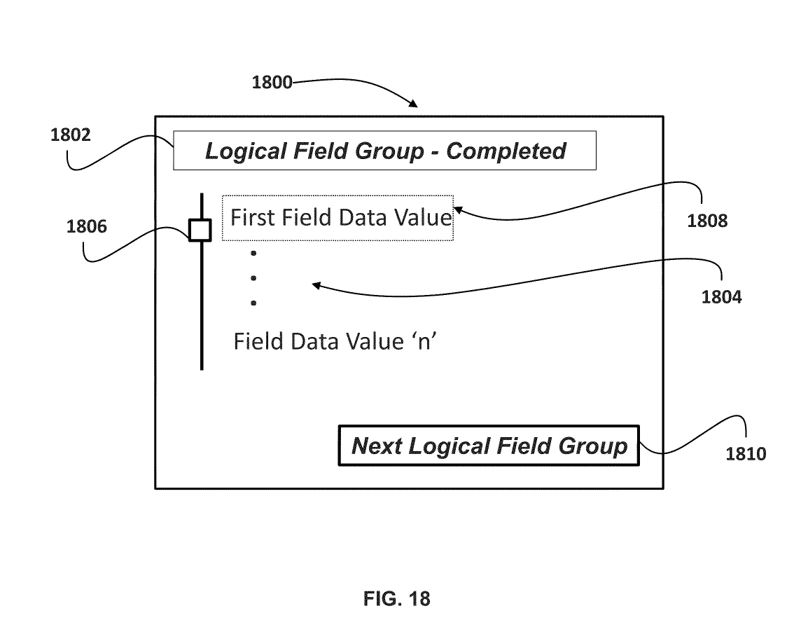

FIG. 18 is an interface 1800, according to one embodiment, to verify 1012 interpreted field data values at conclusion of each logical field group 406. At the end of the entry of input data for all fields in a given logical field group 406, form users 514 may then be presented with an interface 1800 to review and verify interpreted field data values (e.g., input data interpreted and/or assigned to a variable for a given field). The review may also function as a possible “mental break” before advancing with additional input data entry. The nature of a logical field group 406, as previously defined, is fields serving a single business requirement. As such, successive entry of its fields may be more intuitive and easier to do without additional instruction than attempting entry of all form fields, which may be diverse in scope, in succession without a “break.” The interface 1800 is a chance for the form user 514 to inspect and feel good that the field data values are captured and correct so far, and to prepare to start the following data entry session. Again, the interactive area of some computing devices is small and entering form content data on them can be done in reasonable steps compared to the viewable area of the computing device.

The interface 1800 may provide the logical field group name 1802 that was just completed as a guide to the form user 514 of the scope of the included field data values. Below the logical field group name 1802 is a list 1804 of the field data values interpreted in entering results for each field 1010 in the logical field group 406. If the list is too large to fit in the interactive area of the computing device, a sliding device 1806 may be provided to scroll through all results. Each field data value is an active area 1808 that may be selected to automatically route to the entry of the field to re-do its entry in the case the form user 514 identifies an incorrect value. Once the form user 514 is satisfied that the appropriate field data values corresponding to the given logical field group 406 have been correctly interpreted, the “Next logical field group” button 1810 is selected and the form user is presented with the first field entry for the next remaining logical field group 406.

Form users 514 then continue through the remaining logical field groups 406 and confirm 1014 completion at the conclusion of each logical field group 406. Finally, form users 514 mark 1016 the data entry session for export to third-party application 510 as a completion of the form content capture and recognition. The results are now ready for submission to the business process. Form users 514 can then begin anew the flow diagram 1000 of the form users' responsibilities.

### Implementation of Voice Recognition in Form Content Data Entry

Some computing devices such as mobile computing devices may include a limited-use or miniaturized physical keyboard. Some computing devices such as mobile computing devices may only have a virtual keyboard. Entry of form content data on such limited-use, miniaturized, virtual, and other non-ideal keyboards may be ineffective compared to that on full-sized physical keyboards. Entry of form content data on virtual keyboards may be further frustrated by the need to continually access and close the virtual keyboard between entry of successive fields. The present disclosure includes embodiments for input data entry by voice recognition, to more efficiently capture form content data on all computing devices.

Data entry in some computing devices, especially mobile computing devices such as smartphones, tablets, and others, is primarily designed for person-to-person communication fulfilled through texting, email, and other data-entry based communication processes. Their data entry interfaces are often idealized to capture words found in the standard dictionary of the given language, what might be referred to as “whole language communication.” Form content data may be very different from whole language communication. Form content data may include irregular combinations of alphanumeric data not found in standard dictionaries. Examples of such irregular combinations of alphanumeric form content data may include, but are not limited to, serial numbers, street addresses, proper names, account numbers, part numbers, diagnostic codes, phone numbers, and more. Data entry of these examples and others may conflict with the idealized data entry processes found in some computing devices for whole language communication. Similarly, implementation of voice recognition for capture of form content data may require implementing character-by-character voice repetition—spelling each alphanumeric field value—rather than traditional implementations of voice recognition in computing devices which are often also idealized for whole language communication.

One example of how idealized data entry processes found in some computing devices for whole language communication may hinder efficient input data entry is predictive text entry processes found in many mobile computing devices. Predictive text entry uses patterns or possible patterns of entered value to predict and present the correct whole word the user may intend in hopes of alleviating the difficulty of hitting several keys in perfect succession on a small keyboard. For some computing devices, the keyboard is so small that perfect and consistent spelling is unrealistic. An example of predictive text entry processes found in some current computing devices is “Swype,” which allows users to slide their finger in a continuous stroke on a virtual keyboard to create a pattern that may be used to predict the intended whole word. Another example is processes that continually present best-fit words as the user enters letter by letter. Another example is voice recognition that accesses a database of standard whole words to try to match the intended word with the interpreted voice repetition. There may be many other examples. In these examples, and others, the results can be quite successful when the goal of the data entry is standard dictionary terms, even with hurried, inaccurate keyboard actions or voice recording. However, they can also be limiting and terribly frustrating when attempting to enter form content data that is irregular combinations of alphanumeric characters, especially when predictive text processes override intended entries. In certain computing devices that have such predictive data entry processes, it may be possible to disable the process, but doing so may overly reduce the effectiveness of the data entry interface to the point data entry is inefficient or even impossible.

Since form content data may often be irregular combinations of alphanumeric characters, successful entry may depend on accurate character-by-character entry. Possible interfaces in some computing devices may include, but are not limited to, keyboard (virtual or physical) entry, character-by-character writing on an interactive surface of the computing device, or voice recognition of verbal spelling. Each of these interfaces, and perhaps others, may be successfully implemented in the system 500 and other disclosed systems and methods.

As described above, FIG. 15 is an interface 1500 to enter a text field with no expected values. This interface could receive any combination of alphanumeric characters. Effective entry using this text field interface may require character-by-character voice recognition. Predictive text entry, regardless of its implementation, whether by keyboard entry, voice, or other, may by definition prevent effective entry. Additionally, accessing a virtual keyboard as may be found in certain computing devices may make the interface 1500 less effective. Voice recognition, character by character, may allow the simplicity of design for fast and effective text entry in the interface 1500.

As described above, FIG. 16 is an interface 1600 to enter a text field with pre-set, expected values. Effective entry using this text field interface may require character-by-character voice recognition if the expected values are irregular combinations of alphanumeric characters. Predictive text entry, regardless of its implementation, whether by keyboard entry, voice, or other, may also be effective in this interface 1600 if the expected values are standard dictionary terms. However, accessing a virtual keyboard as may be found in certain computing devices may make the interface 1600 less effective so voice recognition, character by character or otherwise, may allow the simplicity of design for fast and effective text entry in the interface 1600.

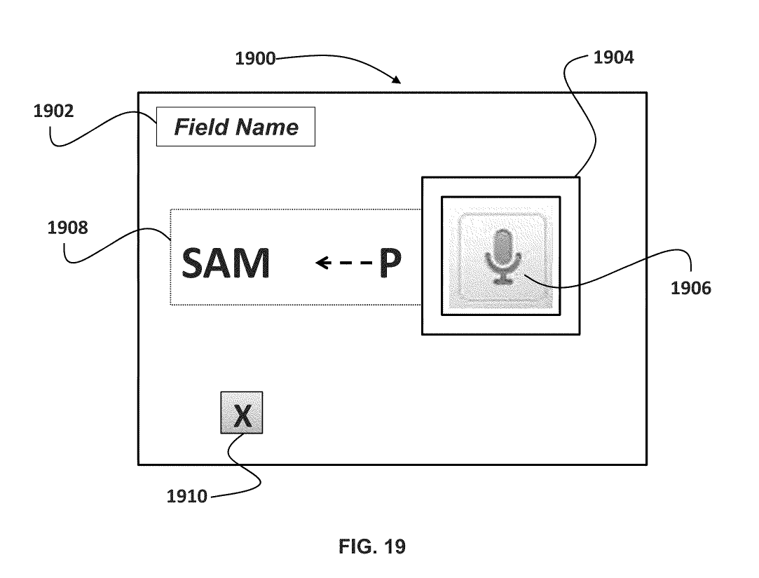

FIG. 19 is an interface, according to one embodiment, to implement character-by-character voice recognition. The Field Name 1902 is presented as a possible guide to the form user 514 to know the desired response or entry type for the field. Optionally a field description (e.g., an inquiry) may be included to describe the type of information (e.g., input data) being requested and collected. Once the interface is presented, voice recognition may be automatically activated and ready to receive data. The status of voice recognition may be indicated by a color outline 1904, green for on and red for stopped for example. If a form user 514 wishes to stop the voice recognition, they may so select by touching the voice recognition icon 1906 which may toggle the activation of the voice recognition allowing the form user 514 to at any time pause their form data entry. With the voice recognition active, the form user 514 begins to spell the field data value, character by character. As the voice recognition works, the recognized characters are presented individually, possibly in real-time, in the recognition presentation area 1908.

In the example of FIG. 19, a form user 514 has begun to spell the word “sample” as “S-A-M” and most recently “P”. The “P” is showing as moving to the left as in the example, because it has been most recently recognized and the interface is building the word right to left, the way the word is naturally read. Such an interface, presenting each letter in succession as it is recognized and presenting it right to left may assist a form user 514 to observe their data entry in real-time.

The recognition presentation area 1908 may also be an active area in the interface allowing the form user 514 to both select and confirm the input data—again in the case of FIG. 19 possibly eventually confirming “SAMPLE” as the intended input data for the field once the form user 514 completes the characters of the input data. If there has been an error in the voice recognition, the form user 514 can select the delete button 1910, and thereby delete the input data in the recognition presentation area 1908 and restart entry.

Some voice recognition processes on computing devices do not run locally on the given computing device, but require an active data connection to a separate cloud service that hosts the voice recognition service. For most voice recognition data entry processes common on computing devices the delay to reach the remote service is an acceptable delay. Such a brief delay may not be acceptable in entry of form content data, especially with multiple fields in succession. Additionally, form content data is often collected remotely where active data connections may not be available or reliable. Implementation of character-by-character voice recognition for input data entry may require immediate and totally disconnected recognition. In one embodiment, character recognition of form content data would be entirely installed locally on the given computing device.

### Keyboard Data Entry

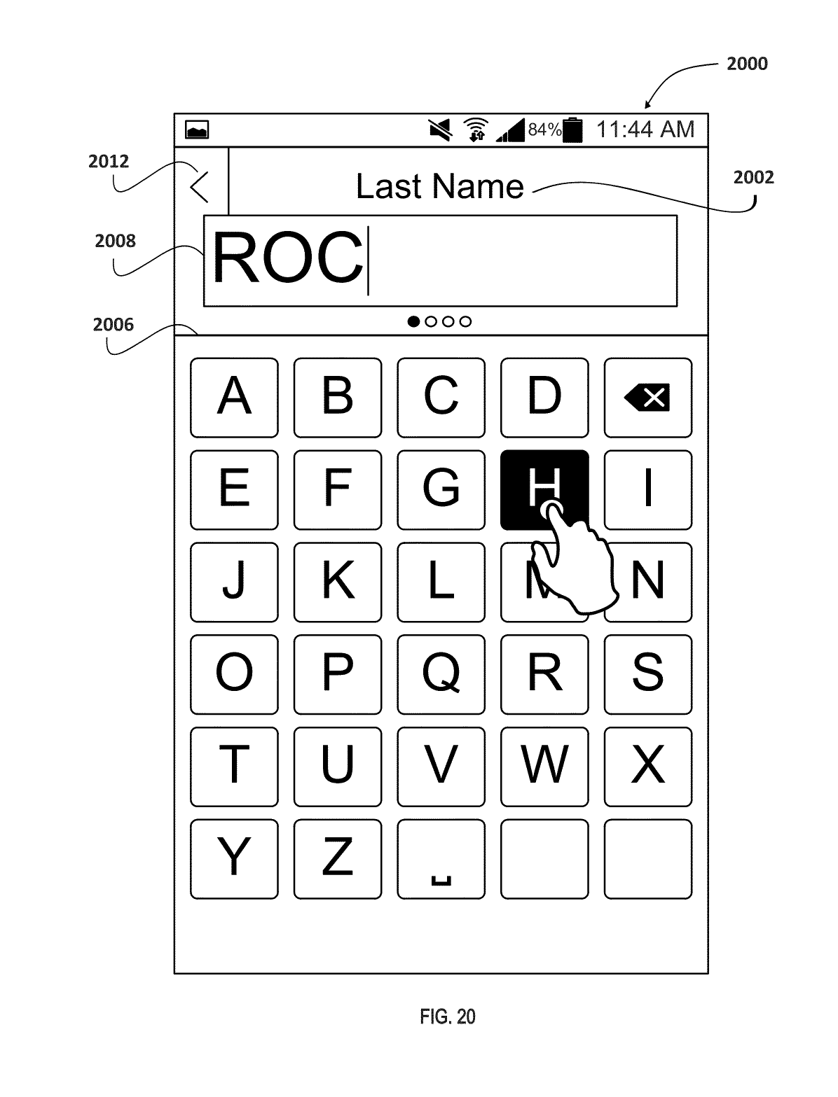

FIG. 20 is virtual keyboard interface 2000 of a form data capture device, according to one embodiment. The interface 2000 allows a form user 514 (see FIG. 5) to type characters into a text field. The virtual keyboard interface 2000 may be an alternative input data entry method to the voice recognition methods described above. The Field Name 2002, in this case Last Name, is presented as a possible guide to the form user 514 to know the desired response or entry type for the field. Optionally a field description (e.g., an inquiry) may be included to describe the type of information (e.g., input data) being requested and collected.

A virtual keyboard 2006 is presented that includes alpha and/or numeric keys (i.e., input components such as virtual buttons). In the illustrated embodiment of FIG. 20, the keys shown are alphabet characters presented in alphabetical order, unlike a standard QWERTY keyboard. On a form data capture device having a display screen with a limited viewing area (e.g., a mobile phone or similar handheld device), presentation of a QWERTY keyboard can result in reduction of key size to be so small that input data entry is challenging to a user and efficient input data entry is difficult. The QWERTY keyboard cannot be reformatted or rearranged, so the size of the keyboard keys is limited by a width of the display screen. By contrast, the keys of the virtual keyboard 2006 are arranged in alphabetical order and the number of keys on a row of the keyboard 2006 can be varied. In the illustrated embodiment, the keyboard 2006 has five keys per row. The keyboard 2006 includes four wildcard keys, which include a backspace, a space, and two unconfigured wildcard keys.

In the embodiment of FIG. 20, the keyboard 2006 may be configured by a user 514 and/or by a form administrator 512 (see FIG. 5). A form user 514 may set a keyboard preference in a setting, for example, on the form data capture device. The form user 514 may be enabled to configure the keyboard 2006 at a field type level. In other words, the form user 514 may be enabled to configure a given field to be presented with the keyboard 2006 and may be enabled to configure the size/dimensions, keyboard type, and/or wildcard keys of the keyboard 2006. A form administrator 512 may also be enabled, when defining a protocol 402 (see FIG. 4) to specify a keyboard and/or configure the keyboard. In this manner, the interface 2000 presents a keyboard 2006 that includes the characters the form user 514 needs and in a size that is comfortable for the user, or that the user prefers, to provide input data entry.

As characters are typed, the characters are presented in a presentation area 2008. The presentation area 2008 may also be an active area in the interface 2000, allowing the form user 514 to both confirm the input data as the intended input data for the field and to advance to the next field. The form user 514 may also be able to swipe across the screen to confirm the input data and advance to the next field.

As can be appreciated, although the virtual keyboard 2006 of FIG. 20 depicts only alphabet characters, other embodiments and configurations are possible. For example, numeric keys can be presented. As another example, symbol keys can be presented. In other embodiments, a combination of alphanumeric keys can be presented and combinations with symbols are also possible. A toggle key may enable toggling between two or more different keyboards.

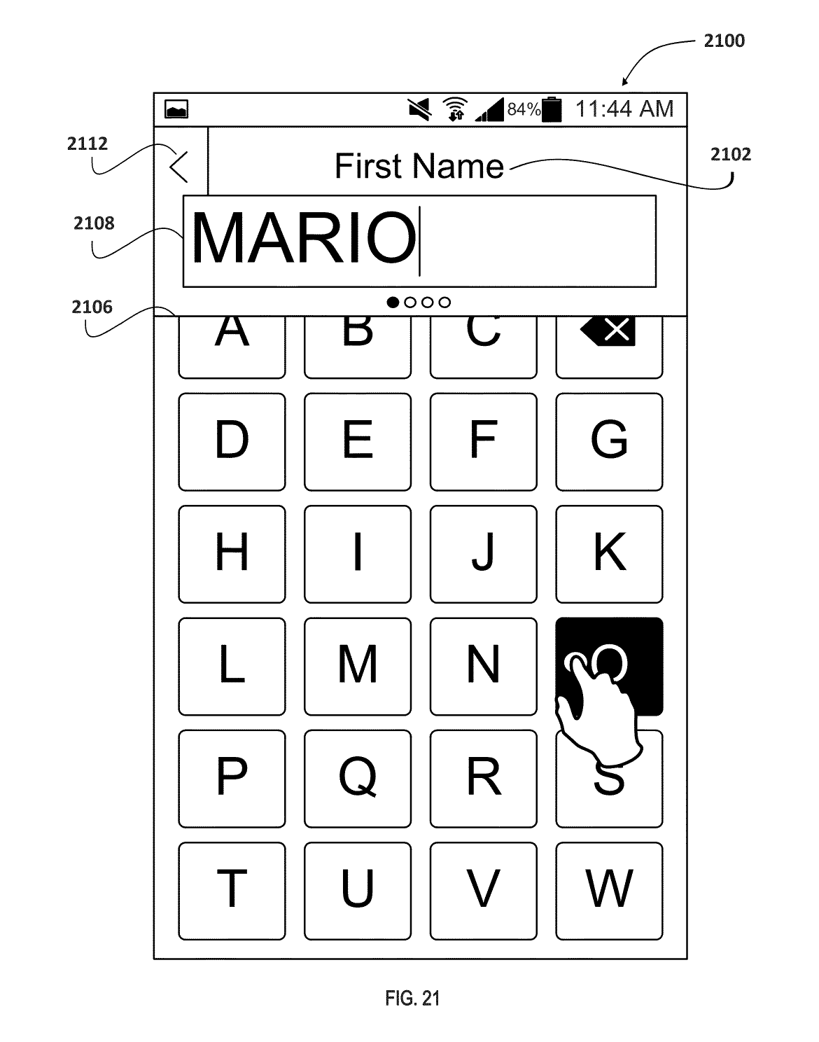

FIG. 21 is virtual keyboard interface 2100 of a form data capture device, according to another embodiment. Similar to the interface 2000 of FIG. 20, the interface 2100 of FIG. 21 allows a form user 514 (see FIG. 5) to type characters into a text field. The Field Name 2102, in this case First Name, is presented as a possible guide to the form user 514 to know the desired response or entry type for the field. A virtual keyboard 2106 is presented that includes alpha and/or numeric keys (i.e., input components such as virtual buttons). In the illustrated embodiment of FIG. 21, the keys shown are alphabet characters presented in alphabetical order, unlike a standard QWERTY keyboard. In the illustrated embodiment, the keyboard 2106 has four keys per row. The keyboard 2106 includes a backspace and may include one or more wildcard keys which may be configurable, for example, by a form user 512 using a preference setting for a field type, or by a form administrator 514 at a field 408 level in a protocol 402 (see FIGS. 4 and 5), as described above with reference to FIG. 20. In this manner, the interface 2100 presents a keyboard 2106 that includes the characters the form user 514 may need and in a size that is comfortable for the user, or that the user prefers, to provide input data entry.

In the embodiment of FIG. 21, the virtual keyboard 2106 is configured such that the size does not completely fit (cannot be entirely displayed) on the display screen having a limited viewing area. The keyboard 2106 is sized to be larger than the display screen and/or the space on the display screen apart from a presentation area 2008. In the illustrated embodiment, a height dimension of the keyboard 2106 is larger than a height dimension of an available area within the screen. To accommodate the size discrepancy, the virtual keyboard 2106 is scrollable. For example, a finger swipe up or down scrolls the keyboard 2106 in a corresponding direction.

As characters are typed, the characters are presented in a presentation area 2108. The presentation area 2108 may also be an active area in the interface 2100 allowing the form user 514 to both confirm the input data as the intended input data for the field and to advance to the next field. The form user 514 may also be able to swipe across the screen to confirm the input data and advance to the next field.

### Device for Form Data Collection

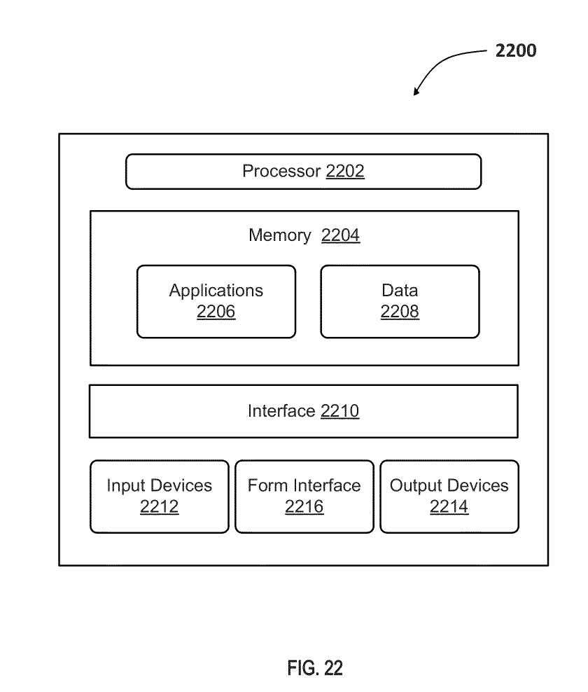

FIG. 22 is a schematic diagram of a form data capture device 2200, according to one embodiment of the present disclosure. The device 2200 includes a processor 2202, memory 2204 to store applications 2206 and data 2208 and the like, and an interface 2210. The interface 2210 may include any type of well-known interface standard, such as an Ethernet interface, a universal serial bus (USB), etc. The interface 2210 may also include a graphics driver card. The interface 2210 may also include a communication driver to facilitate exchange of data with external computers via a network (e.g., an Ethernet connection, a digital subscriber line (DSL), a telephone line, coaxial cable, a cellular telephone system, etc.). The interface 2210 may include a network interface card.

One or more input devices 2212 may couple to the interface 2210. The one or more input devices 2212 may include, but are not limited to, a keyboard, a mouse, a touch screen, a track-pad, a trackball, isopoint, and/or a voice recognition system.

One or more output devices 2214 may also couple to the interface 2210. The one or more output devices 2214 may include, but are not limited to, display devices (monitor, projector, screen, touchscreen, or the like), a printer, and/or speakers.

The form data capture device 2200 may also include a form interface 2216. The form interface 2216 may implement the method and functionalities described above. The form interface 2216 may couple to the interface 2210 to receive form content, for example, from a Form Content Control and Distribution Server 504 (see FIG. 5), from a website, or from another source. The form interface 2216 may also couple to the interface 2210 to utilize one or more of the input devices 2212 to receive input data from a form user 514. The form interface 2216 may also couple to the interface 2210 to utilize one or more of the output devices 2214, such as to present fields on a display screen (e.g., a touch screen). The form interface 2216 may also couple to the interface 2210 to provide form data to an application 2206 (e.g., a third-party application) on the form data capture device 2200 or to a third-party application 510 (see FIG. 5) on a remote computing device. In other embodiments, the form interface 2216 may interact directly with the input devices 2212, the output devices 2214, and/or the applications 2206.

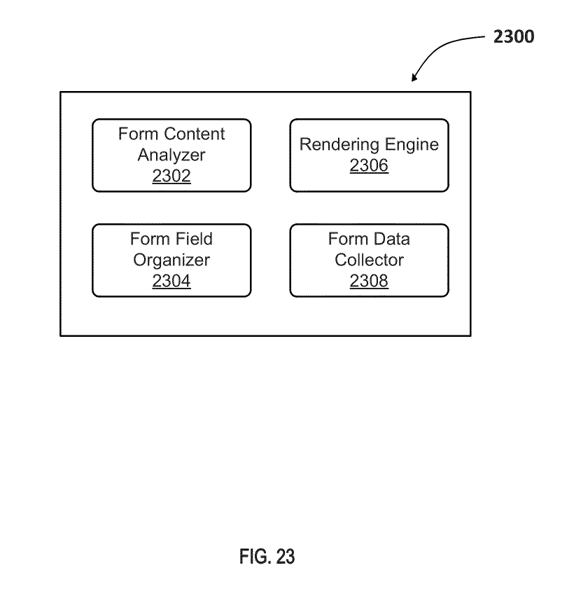

FIG. 23 is a schematic diagram of a form interface 2300 of a form data capture device, according to one embodiment of the present disclosure. The form interface 2300 may be the form interface 2216 of the form data capture device 2200 of FIG. 22. The form interface 2300 may include a form content analyzer 2302, a form field organizer 2304, a rendering engine 2306, and a form data collector 2308.

The form content analyzer 2302 may analyze data specifying a plurality of fields for collecting input data from a user of the form data capture device. The form content analyzer 2302 may identify one or more logical field groups into which the plurality of fields can be organized. The data analyzed by the form content analyzer 2302 may be a protocol received from a server computing device. The data analyzed may be a web page or other electronic document.

The form field organizer 2304 may associate each field of the plurality of fields with a grouping selected from among one or more groupings corresponding to the one or more logical field groups and defined within the memory of the computing device. The form field organizer 2304 may specify in the grouping an ordering of all fields assigned to the grouping. In some embodiments, a protocol may specify one or more groupings to define within the computing device, and an association of each field to a grouping of the one or more groupings.

The rendering engine 2306 may present in series, one at time, on a display screen, each of the fields assigned to each grouping of the one or more groupings. The rendering engine may present the fields according to the ordering specified in each grouping.

The form data collector 2308 may collect input data entered using the plurality of fields during a data entry session. The form data collector 2308 may incorporate the input data into form data for the data entry session. The form data collector 2308 may be further configured to provide the form data for the data entry session to a separate third-party application. The form data collector 2308 may package the form data according to a desired format receivable by the third-party application. The third-party application may be local on the form data collector 2308 (e.g., a web browser) or may be remote on a remote computing device coupled to a network to which the form data capture device may connect.

### EXAMPLES

Examples of embodiments of the present disclosure are provided below.

### Example 1

A method for inputting data into a computing device, comprising: obtaining on the computing device data specifying a plurality of fields into which input data can be entered to provide that input data to the computing device; associating on the computing device each field of the plurality of fields to a field group defined within the computing device, wherein the field group specifies an ordering of all fields assigned to the field group; presenting in series, one at a time, on a display screen of the computing device, each of the fields assigned to the field group, wherein the presenting is according to the ordering specified in the field group; receiving input data entered into each field of the plurality of fields during a data entry session to incorporate the input data into form data corresponding to the data entry session; and making the form data accessible to a third-party application.

### Example 2

The method of claim 1, wherein making the form data accessible to the third-party application comprises providing the form data to an application on the computing device.

### Example 3

The method of claim 1, wherein making the form data accessible to the third-party application comprises transmitting the form data over a network to an application on a remote computing device.

### Example 4

The method of claim 1, wherein receiving the input data entered into each field comprises: receiving a single confirmation input action upon receiving data entered into a given field of the plurality of fields during the data entry session; and in response to receiving the single confirmation input action: confirming the input data has a correct format for the given field; and advancing to present a next field of the plurality of fields.

### Example 5

The method of claim 4, wherein, also in response to receiving the single confirmation input action, the input data is incorporated into the form data corresponding to the data entry session.

### Example 6

The method of claim 1, further comprising: analyzing the data specifying the plurality of fields to identify one or more logical field groups into which the plurality of fields can be organized, wherein the field group to which each field is assigned is selected from among a plurality of field groups that correspond to the plurality of logical field groups and that are defined within the memory of the computing device, and wherein presenting in series, one at a time, each of the fields assigned to the field group further comprises presenting, in series, one at a time, each of the fields assigned to each field group of the plurality of field groups, and wherein the presenting of the fields assigned to a given field group is according to the ordering specified by the given field group.

### Example 7

The method of claim 6, wherein the plurality of field groups is organized according to a protocol received on the computing device, the protocol specifying an ordering of the plurality of field groups, wherein presenting in series, one at a time, each of the form fields is according to the ordering specified in the plurality of field groups and the ordering of the plurality of field groups specified in the protocol.

### Example 8

The method of claim 1, wherein presenting in series, one at a time, each of the fields comprises optimizing an interface that is presented, the optimizing based on a type of the field and/or one or more properties of the field.

### Example 9

The method of claim 8, wherein optimizing comprises setting a correct format for input data received for the field.

### Example 10

The method of claim 8, wherein optimizing comprises setting a navigation action to confirm the input data and advance presentation to a next field.

### Example 11

The method of claim 1, further comprising: determining a standard for a reasonable number of fields to be entered in succession; comparing a number of fields assigned to each field group of the one or more field groups against the standard for a reasonable number of fields; and separating into multiple field groups of the plurality of field groups each field group that has a number of fields larger than the standard.

### Example 12

The method of claim 1, wherein the fields assigned to the field group are collectively configured to collect data for an information requirement of an organization process.

### Example 13

The method of claim 1, wherein the data specifying the plurality of fields comprises a webpage.

### Example 14

The method of claim 1, wherein the data specifying the plurality of fields comprises an electronic document.

### Example 15

The method of claim 1, wherein obtaining on the computing device data specifying a plurality of fields comprises receiving a protocol from a server computing device, the protocol specifying the plurality of fields, one or more field groups to define within the computing device, and an association of each field to a field group of the one or more field groups.

### Example 16

The method of claim 15, wherein the protocol specifies an ordering of the one or more field groups, wherein the presenting in series, one at a time, each of the form fields is according to the ordering specified in the plurality of field groups and the ordering of the plurality of field groups specified in the protocol.

### Example 17

The method of claim 1, further comprising specifying a data type of each form field.

### Example 18

The method of claim 1, further comprising assigning an input tool to the form field.

### Example 19

The method of claim 18, wherein the input tool is one of a QWERTY keyboard, a modified keyboard, and a voice recorder.

### Example 20

A device for form data collection, comprising: a processor; a memory in communication with the processor; a display screen; a form content analyzer to analyze data specifying a plurality of fields for collecting input data from a user of the device and to identify one or more logical field groups into which the plurality of fields can be organized; a form field organizer to associate, on the device, each field of the plurality of fields with a grouping selected from among one or more groupings corresponding to the one or more logical field groups and defined within the memory of the computing device, wherein the grouping specifies an ordering of all fields assigned to the grouping; a rendering engine configured to present in series, one at time, on the display screen, each of the fields assigned to each grouping of the one or more groupings, the presenting according to the ordering specified in each grouping; and a form data collector to collect input data entered using the plurality of fields during a data entry session and to incorporate the input data into form data for the data entry session.

### Example 21

The device of claim 20, wherein the form data collector is further configured to provide the form data for the data entry session to a separate third-party application.

### Example 22

The device of claim 21, wherein providing the form data to the third-party application comprises transmitting the form data over a network to an application on a remote computing device.

### Example 23

The device of claim 20, wherein the rendering engine is further configured, while presenting a single given field of the plurality of fields, to receive a single confirmation input action, and in response to receiving the single confirmation input action: confirm the input data has a correct form for the given field; and advance to present a next field of the plurality of fields.

### Example 24

The device of claim 23, wherein, also in response to receiving the single confirmation input action, the form data collector collects the input data of the given field and incorporates the input data into the form data corresponding to the data entry session.

### Example 25

The device of claim 20, wherein the presenting in series, one at a time, each of the fields comprises optimizing an interface that is presented, the optimizing based on a type of the field.

### Example 26

The device of claim 20, wherein all the fields assigned to each grouping of the one or more groupings are collectively configured to collect data for an information requirement of an organization process.

### Example 27

The device of claim 20, wherein the form content analyzer identifies a plurality of logical field groups, wherein each form field is assigned to a grouping selected from among a plurality of groupings corresponding to the plurality of logical field groups, and wherein the plurality of groupings is configured to collect data for a plurality of information requirements.

### Example 28

The device of claim 20, wherein the data specifying the plurality of fields comprises a protocol received from a server computing device, the protocol further specifying the one or more groupings to define within the computing device, and an association of each field to a grouping of the one or more groupings.

### Example 29

The device of claim 28, wherein the protocol specifies an ordering of the one or more groupings, and wherein the rendering engine is configured to present in series, one at a time, each of the form fields according to the ordering specified in the plurality of field groups and the ordering of the plurality of field groups specified in the protocol.

### Example 30

A computer-readable medium having stored thereon instructions that, when executed by a processor, cause the processor to perform operations comprising: obtaining on the computing device data specifying a plurality of fields into which input data can be entered to provide that input data to the computing device; associating on the computing device each field of the plurality of fields to a field group defined within the computing device, wherein the field group specifies an ordering of all fields assigned to the field group; and presenting in series, one at a time, on a display screen of the computing device, each of the fields assigned to the field group, wherein the presenting is according to the ordering specified in the field group; receiving input data entered into each field of the plurality of fields during a data entry session to incorporate the input data into form data corresponding to the data entry session; and making the form data accessible to a third-party application.

### Example 31

The computer-readable medium of claim 30, wherein receiving the input data entered into each field comprises: receiving a single confirmation input action upon receiving data entered into a given field of the plurality of fields during the data entry session; and in response to receiving the single confirmation input action: confirming the input data has a correct form for the given field; advancing to present a next field of the plurality of fields; and incorporating the input data into the form data corresponding to the data entry session.

### Example 32

A method for presenting a form for data collection on a computing device, comprising: receiving on the computing device data specifying a plurality of fields of the form, the fields to collect input data; assigning on the computing device each field of the plurality of fields to a field group defined within the computing device, wherein the field group specifies an ordering of all fields assigned to the field group; and presenting in series, one at a time, on a display screen of the computing device, each of the fields assigned to the field group, the presenting according to the ordering specified in the field group.

### Example 33

The method of claim 32, wherein assigning each field of the plurality of form fields to a field group comprises associating each field with a field group data structure on the computing device.

### Example 34

The method of claim 32, wherein the fields assigned to the field group are collectively configured to collect data for an information requirement of an organization process.

### Example 33

The method of claim 32, further comprising: determining a standard for a reasonable number of fields to be addressed in succession; comparing a number of fields assigned to each field group of the one or more field groups against the standard for a reasonable number of fields; and refining each field group of the one or more field groups that has a number of fields larger than the standard for a reasonable number of fields, wherein the refining of a given field group is accomplished by separating into multiple field groups of the plurality of field groups each field assigned to the given field group that has a number of fields larger than the standard.

### Example 34

A method for data collection on a computing device, the method comprising: receiving a form configured to collect data for one or more information requirements of an organization process; identifying one or more field groups each configured to collect data for an information requirement of the one or more information requirements; identifying a plurality of form fields of the form and associating each form field of the plurality of form fields with a field group of the one of more field groups; presenting in series, one at a time, on a display screen of the computing device, each of the fields assigned to each field group of the one or more field groups, wherein the presenting is according to an ordering specified in the field group; and receiving input data entered into each of the plurality of fields during a data entry session and incorporating the input data into form data corresponding to the data entry session.

### Example 35

A method for data collection on a computing device, the method comprising: receiving at the computing device a protocol defining a plurality of fields to collect data for one or more information requirements of an organization process, defining one or more field groups, and specifying an ordering of the one or more field groups, wherein each field is associated with a field group of the one or more field groups, wherein each field group of the one or more field groups specifies an ordering of all associated fields; presenting in series, one at a time, on a display screen of the computing device, each of the fields assigned to each field group of the one or more field groups, wherein the presenting is according to the ordering specified in the field group; and receiving input data entered into each of the plurality of fields during a data entry session and incorporating the input data into form data corresponding to the data entry session.

### Example 36

A method for data collection on a computing device, the method comprising: receiving at a server computing device data defining a protocol including: receiving data specifying a plurality of fields, receiving data specifying one or more field groups, receiving an ordering of the one or more field groups, receiving an association of each field with a field group of the one or more field groups, and receiving for each field group of the one or more field groups, an ordering of all associated fields; and providing the protocol to a client computing device configured to present in series, one at a time, on a display screen of the client computing device, each of the fields assigned to each field group of the one or more field groups, wherein the presenting is according to the ordering of the one or more field groups and the ordering specified in each field group of the one or more field groups.

The above description provides numerous specific details for a thorough understanding of the embodiments described herein. However, those of skill in the art will recognize that one or more of the specific details may be omitted, or other methods, components, or materials may be used. In some cases, operations are not shown or described in detail.

Furthermore, the described features, operations, or characteristics may be combined in any suitable manner in one or more embodiments. It will also be readily understood that the order of the steps or actions of the methods described in connection with the embodiments disclosed may be changed as would be apparent to those skilled in the art. Thus, any order in the drawings or Detailed Description is for illustrative purposes only and is not meant to imply a required order, unless specified to require an order.

Embodiments may include various steps, which may be embodied in machine-executable instructions to be executed by a general-purpose or special-purpose computer (or other electronic device). Alternatively, the steps may be performed by hardware components that include specific logic for performing the steps, or by a combination of hardware, software, and/or firmware.

Embodiments may also be provided as a computer program product including a computer-readable storage medium having stored instructions thereon that may be used to program a computer (or other electronic device) to perform processes described herein. The computer-readable storage medium may include, but is not limited to: hard drives, floppy diskettes, optical disks, CD-ROMs, DVD-ROMs, ROMs, RAMs, EPROMs, EEPROMs, magnetic or optical cards, solid-state memory devices, or other types of medium/machine-readable medium suitable for storing electronic instructions.

As used herein, a software module or component may include any type of computer instruction or computer executable code located within a memory device and/or computer-readable storage medium. A software module may, for instance, comprise one or more physical or logical blocks of computer instructions, which may be organized as a routine, program, object, component, data structure, etc. that performs one or more tasks or implements particular abstract data types.

In certain embodiments, a particular software module may comprise disparate instructions stored in different locations of a memory device, which together implement the described functionality of the module. Indeed, a module may comprise a single instruction or many instructions, and may be distributed over several different code segments, among different programs, and across several memory devices. Some embodiments may be practiced in a distributed computing environment where tasks are performed by a remote processing device linked through a communications network. In a distributed computing environment, software modules may be located in local and/or remote memory storage devices. In addition, data being tied or rendered together in a database record may be resident in the same memory device, or across several memory devices, and may be linked together in fields of a record in a database across a network.

This disclosure has been made with reference to various exemplary embodiments, including the best mode. However, those skilled in the art will recognize that changes and modifications may be made to the exemplary embodiments without departing from the scope of the present disclosure. While the principles of this disclosure have been shown in various embodiments, many modifications of structure, arrangements, proportions, elements, materials, and components may be adapted for a specific environment and/or operating requirements without departing from the principles and scope of this disclosure. These and other changes or modifications are intended to be included within the scope of the present disclosure.

This disclosure is to be regarded in an illustrative rather than a restrictive sense, and all such modifications are intended to be included within the scope thereof. Likewise, benefits, other advantages, and solutions to problems have been described above with regard to various embodiments. However, benefits, advantages, solutions to problems, and any element(s) that may cause any benefit, advantage, or solution to occur or become more pronounced are not to be construed as a critical, required, or essential feature or element. The scope of the present invention should, therefore, be determined by the following claims:

1. A method for inputting data into a computing device, comprising:
obtaining on the computing device data specifying a plurality of fields into which input data can be entered;
associating on the computing device each field of the plurality of fields to a field group defined within the computing device, wherein the field group specifies an ordering of all fields assigned to the field group;
presenting in series, one at a time, on a display screen of the computing device, each of the fields assigned to the field group, wherein the presenting occurs according to the ordering specified in the field group;
receiving input data entered into each field of the plurality of fields during a data entry session to incorporate the input data into form data corresponding to the data entry session; and
making the form data accessible to a third-party application.

2. The method of claim 1, wherein making the form data accessible to the third-party application comprises providing the form data to an application on the computing device.

3. The method of claim 1, wherein making the form data accessible to the third-party application comprises transmitting the form data over a network to an application on a remote computing device.

4. The method of claim 1, wherein receiving the input data entered into each field comprises:
receiving a single confirmation input action upon receiving data entered into a given field of the plurality of fields during the data entry session; and
in response to receiving the single confirmation input action:
confirming the input data has a correct format for the given field; and
advancing to present a next field of the plurality of fields.

5. The method of claim 4, wherein, also in response to receiving the single confirmation input action, the input data is incorporated into the form data corresponding to the data entry session.

6. The method of claim 1, further comprising:
analyzing the data specifying the plurality of fields to identify one or more logical field groups into which the plurality of fields can be organized,
wherein the field group to which each field is assigned is selected from among a plurality of field groups that corresponds to the plurality of logical field groups and that is defined within the memory of the computing device, and
wherein presenting in series, one at a time, each of the fields assigned to the field group further comprises presenting, in series, one at a time, each of the fields assigned to each field group of the plurality of field groups, and wherein the presenting of the fields assigned to a given field group is according to the ordering specified by the given field group.

7. The method of claim 6, wherein the plurality of field groups is organized according to a protocol received on the computing device, the protocol specifying an ordering of the plurality of field groups,
wherein presenting in series, one at a time, each of the form fields is according to the ordering specified in the plurality of field groups and the ordering of the plurality of field groups specified in the protocol.

8. The method of claim 1, wherein presenting in series, one at a time, each of the fields comprises optimizing an interface that is presented, the optimizing based on a type of the field.

9. The method of claim 1, wherein the data specifying the plurality of fields comprises a webpage.

10. The method of claim 1, wherein the data specifying the plurality of fields comprises an electronic document.

11. The method of claim 1, wherein obtaining on the computing device data specifying a plurality of fields comprises receiving a protocol from a server computing device, the protocol specifying the plurality of fields, one or more field groups to define within the computing device, and an association of each field to a field group of the one or more field groups.

12. The method of claim 11, wherein the protocol specifies an ordering of the one or more field groups,
wherein the presenting in series, one at a time, each of the form fields is according to the ordering specified in the plurality of field groups and the ordering of the plurality of field groups specified in the protocol.

13. A device for form data collection, comprising:
a processor;
a memory in communication with the processor;
a display screen;
a form content analyzer to analyze data specifying a plurality of fields for collecting input data from a user of the device and to identify one or more logical field groups into which the plurality of fields can be organized;
a form field organizer to associate, on the device, each field of the plurality of fields with a grouping selected from among one or more groupings corresponding to the one or more logical field groups and defined within the memory of the computing device, wherein the grouping specifies an ordering of all fields assigned to the grouping;
a rendering engine configured to present in series, one at time, on the display screen, each of the fields assigned to each grouping of the one or more groupings, the presenting according to the ordering specified in each grouping; and
a form data collector to collect input data entered using the plurality of fields during a data entry session and to incorporate the input data into form data for the data entry session.

14. The device of claim 13, wherein the form data collector is further configured to provide the form data for the data entry session to a separate third-party application.

15. The device of claim 14, wherein providing the form data to the third-party application comprises transmitting the form data over a network to an application on a remote computing device.

16. The device of claim 13, wherein the rendering engine is further configured, while presenting a single given field of the plurality of fields, to receive a single confirmation input action, and in response to receiving the single confirmation input action:
confirm the input data has a correct form for the given field; and
advance to present a next field of the plurality of fields.

17. The device of claim 16, wherein, also in response to receiving the single confirmation input action, the form data collector collects the input data of the given field and incorporates the input data into the form data corresponding to the data entry session.

18. The device of claim 13, wherein the presenting in series, one at a time, each of the fields comprises optimizing an interface that is presented, the optimizing based on a type of the field.

19. The device of claim 13, wherein the form content analyzer identifies a plurality of logical field groups,
wherein each form field is assigned to a grouping selected from among a plurality of groupings corresponding to the plurality of logical field groups, and
wherein the plurality of groupings is configured to collect data for a plurality of information requirements.

20. The device of claim 13, wherein the data specifying the plurality of fields comprises a protocol received from a server computing device, the protocol further specifying, the one or more groupings to define within the computing device, and an association of each field to a grouping of the one or more groupings.

21. The device of claim 20, wherein the protocol specifies an ordering of the one or more groupings, and
wherein the rendering engine is configured to present in series, one at a time, each of the form fields according to the ordering specified in the plurality of field groups and the ordering of the plurality of field groups specified in the protocol.

22. A computer-readable medium having stored thereon instructions that, when executed by a processor, cause the processor to perform operations comprising:
obtaining on the computing device data specifying a plurality of fields into which input data can be entered to provide that input data to the computing device;
associating on the computing device each field of the plurality of fields to a field group defined within the computing device, wherein the field group specifies an ordering of all fields assigned to the field group;
presenting in series, one at a time, on a display screen of the computing device, each of the fields assigned to the field group, wherein the presenting is according to the ordering specified in the field group;
receiving input data entered into each field of the plurality of fields during a data entry session to incorporate the input data into form data corresponding to the data entry session; and
making the form data accessible to a third-party application.

23. The computer-readable medium of claim 22, wherein receiving the input data entered into each field comprises:
receiving a single confirmation input action upon receiving data entered into a given field of the plurality of fields during the data entry session; and
in response to receiving the single confirmation input action:
confirming the input data has a correct form for the given field;
advancing to present a next field of the plurality of fields; and
incorporating the input data into the form data corresponding to the data entry session.
